(19) United States
(12) Patent Application Publication
(10) Pub. No.: US 2013/0177070 A1
(43) Pub. Date: Jul. 11, 2013

(54) SIGNIFICANCE MAP SUPPORT FOR PARALLEL TRANSFORM COEFFICIENT PROCESSING IN VIDEO CODING

(71) Applicant: QUALCOMM Incorporated, San Diego, CA (US)

(72) Inventors: Vadim Seregin, San Diego, CA (US); Joel Sole Rojals, La Jolla, CA (US); Marta Karczewicz, San Diego, CA (US); Wei-Jung Chien, San Diego, CA (US); Jianle Chen, San Diego, CA (US)

(73) Assignee: QUALCOMM INCORPORATED, San Diego, CA (US)

(21) Appl. No.: 13/738,565

(22) Filed: Jan. 10, 2013

Related U.S. Application Data
(60) Provisional application No. 61/585,598, filed on Jan. 11, 2012.
(60) Provisional application No. 61/586,609, filed on Jan. 13, 2012.
(60) Provisional application No. 61/586,680, filed on Jan. 13, 2012.

(51) Int. Cl. H04N 7/26

(52) U.S. Cl. CPC H04N 19/00072
USPC 375/240.02

(57) ABSTRACT

In an example, aspects of this disclosure relate to a process for video coding that includes determining that a set of support for selecting a context model to code a current significant coefficient flag of a transform coefficient of a block of video data includes at least one significant coefficient flag that is not available. The process also includes, based on the determination, modifying the set of support, and calculating a context for the current significant coefficient flag using the modified set of support. The process also includes applying context-adaptive binary arithmetic coding (CABAC) to code the current significant coefficient flag based on the calculated context.

This application claims priority to U.S. Provisional Application No. 61/585,598, filed 11 Jan. 2012, U.S. Provisional Application No. 61/586,609, filed 13 Jan. 2012, and U.S. Provisional Application No. 61/586,680, filed 13 Jan. 2012, the contents of all of which are hereby incorporated by reference in their entirety.

### TECHNICAL FIELD

This disclosure relates to video coding, and more particularly to techniques for performing intra-prediction when coding video data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards, to transmit, receive and store digital video information more efficiently.

Video compression techniques include spatial prediction and/or temporal prediction to reduce or remove redundancy inherent in video sequences. For block-based video coding, a video frame or slice may be partitioned into blocks. Each block can be further partitioned. Blocks in an intra-coded (I) frame or slice are encoded using spatial prediction with respect to reference samples in neighboring blocks in the same frame or slice. Blocks in an inter-coded (P or B) frame or slice may use spatial prediction with respect to reference samples in neighboring blocks in the same frame or slice or temporal prediction with respect to reference samples in other reference frames. Spatial or temporal prediction results in a predictive block for a block to be coded. Residual data represents pixel differences between the original block to be coded and the predictive block.

An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in a particular order to produce a one-dimensional vector of transform coefficients for entropy coding.

### SUMMARY

The techniques of this disclosure generally relate to entropy coding video data. For example, during entropy coding, a video coder may convert information for transform coefficients into binarized form, thereby generating one or more bits, or “bins.” The video coder may then code each bin of the transform coefficients using probability estimates for each bin, which may indicate a likelihood of a bin having a given binary value. The probability estimates may be included within a probability model, also referred to as a “context model.” A video coder may select a context model by determining a context for the bin. Context for a bin of a syntax element may be determined based on values of related bins of previously coded syntax elements, such as syntax elements associated with other transform coefficients. With respect to coding transform coefficients, the positions of the transform coefficient from which context is derived may be referred to as a context support neighborhood (also referred to as “context support,” or simply “support”).

Aspects of this disclosure relate to calculating context for bins of more than one transform coefficient in parallel. For example, aspects of this disclosure generally include determining a support that allows more than one transform coefficient significance flag to be calculated in parallel. In some instances, according to aspects of this disclosure, one or more positions may be removed from the support to enable parallel context calculation. In some instances, values may be substituted for the removed support positions. Calculating contexts for bins of multiple transform coefficients in parallel in this way may increase coding efficiency.

In an example, aspects of this disclosure relate to a method of coding video data that includes determining that a set of support for selecting a context model to code a current significant coefficient flag of a transform coefficient of a block of video data includes at least one significant coefficient flag that is not available, based on the determination, modifying the set of support, calculating a context for the current significant coefficient flag using the modified set of support, and applying context-adaptive binary arithmetic coding (CABAC) to code the current significant coefficient flag based on the calculated context.

In another example, aspects of this disclosure relate to an apparatus for coding video data that includes one or more processors configured to determine that a set of support for selecting a context model to code a current significant coefficient flag of a transform coefficient of a block of video data includes at least one significant coefficient flag that is not available, based on the determination, modify the set of support, calculate a context for the current significant coefficient flag using the modified set of support, and apply context-adaptive binary arithmetic coding (CABAC) to code the current significant coefficient flag based on the calculated context.

In another example, aspects of this disclosure relate to an apparatus for coding video data that includes means for determining that a set of support for selecting a context model to code a current significant coefficient flag of a transform coefficient of a block of video data includes at least one significant coefficient flag that is not available, based on the determination, means for modifying the set of support, means for calculating a context for the current significant coefficient flag using the modified set of support, and means for applying context-adaptive binary arithmetic coding (CABAC) to code the current significant coefficient flag based on the calculated context.

In another example, aspects of this disclosure relate to a non-transitory computer-readable storage medium having instructions stored thereon that, when executed, cause one or more processors to determine that a set of support for selecting a context model to code a current significant coefficient flag of a transform coefficient of a block of video data includes at least one significant coefficient flag that is not available, based on the determination, modify the set of support, calculate a context for the current significant coefficient flag using the modified set of support, and apply context-adaptive binary arithmetic coding (CABAC) to code the current significant coefficient flag based on the calculated context.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a block diagram illustrating an example video encoding and decoding system 10 that may utilize the techniques of this disclosure for performing parallel context calculation.

FIG. 2 is a block diagram illustrating an example of a video encoder 20 that may use the techniques of this disclosure for performing parallel context calculation.

FIG. 3 is a block diagram illustrating an example of video decoder 30 that may implement techniques for performing parallel context calculation.

FIGS. 4A and 4B generally illustrate diagonal scan patterns for scanning transform coefficients associated with a block of video data during coding.

FIGS. 5A and 5B generally illustrate dividing a block of transform coefficients associated with a block of video data into sub-sets in the form of sub-blocks.

FIG. 6 generally illustrates a context support neighborhood for calculating context.

FIG. 7 generally illustrates a context support neighborhood for calculating more than one context in parallel, according to aspects of this disclosure.

FIGS. 8A-8C generally illustrate context support neighborhoods for calculating more than one context in parallel, according to aspects of this disclosure.

FIG. 9 illustrates an example of introducing holes into support based on the location of the significance flag being coded, according to aspects of this disclosure.

FIG. 10 illustrates an example of introducing holes into support based on a group of significance contexts being calculated in parallel, according to aspects of this disclosure.

FIG. 11 illustrates another example of introducing holes into support based on the location of the significance flag being coded, according to aspects of this disclosure.

FIG. 12 illustrates an example of introducing holes into support based on a group of significance contexts being calculated in parallel, according to aspects of this disclosure.

FIGS. 13A-13C illustrates examples of supports having holes (relative to the five point support described above) that are not position-based, according to aspects of this disclosure.

FIGS. 14A-14C illustrates examples of modified supports having holes (relative to the five point support described above) that are not position-based, according to aspects of this disclosure.

FIG. 15 illustrates applying weights to one or more positions in a set of support for context calculation, according to aspects of this disclosure.

FIGS. 16A and 16B illustrate applying weights to one or more positions in a set of support for context calculation as well as introducing holes to the set of support, according to aspects of this disclosure.

FIGS. 17A and 17B illustrate applying weights to one or more positions in a set of support for context calculation, as well as filling holes in the set of support, according to aspects of this disclosure.

FIG. 18 is a flow diagram illustrating a technique of coding a significance flag, according to aspects of this disclosure.

FIG. 19 is a flow diagram illustrating a technique of entropy coding video data, according to aspects of this disclosure.

### DETAILED DESCRIPTION

A video coding device may attempt to compress video data by taking advantage of spatial and temporal redundancy. For example, a video encoder may take advantage of spatial redundancy by coding a block relative to neighboring, previously coded blocks. Likewise, a video encoder may take advantage of temporal redundancy by coding a block relative to data of previously coded frames. In particular, the video encoder may predict a current block from data of a spatial neighbor or from data of a previously coded frame. The video encoder may then calculate a residual for the block as a difference between the actual pixel values for the block and the predicted pixel values for the block. Accordingly, the residual for a block may include pixel-by-pixel difference values in the pixel (or spatial) domain.

The video encoder may then apply a transform to the values of the residual to compress energy of the pixel values into a relatively small number of transform coefficients in the frequency domain. The video encoder may then quantize the transform coefficients. The video encoder may scan the quantized transform coefficients to convert a two-dimensional matrix of quantized transform coefficients into a one-dimensional vector including the quantized transform coefficients. The process of scanning the coefficients is sometimes referred to as serializing the coefficients.

The video encoder may then apply an entropy coding process to entropy encode the scanned transform coefficients. Example entropy coding processes may include, for example, context-adaptive variable length coding (CAVLC), context-adaptive binary arithmetic coding (CABAC), syntax-based context-adaptive binary arithmetic coding (SBAC), probability interval partitioning entropy (PIPE) coding or other entropy encoding methodologies. In general, unless stated otherwise, the term “transform coefficients” refers to coefficients in the transform domain for a residual block, which may or may not have been quantized. Thus, discussion of entropy coding of transform coefficients should be understood to include entropy coding of unquantized transform coefficients or quantized transform coefficients. The video encoder may also entropy encode syntax elements associated with the encoded video data for use by a video decoder in decoding the video data.

Context coding may be performed on binarized values. For example, a video encoder may convert an absolute value of each value (e.g., transform coefficient levels, symbols, syntax elements, and the like) into binarized form. In this way, each non-zero value being coded may be binarized, e.g., using a unary coding table or other coding scheme that converts a value to a codwoed having one or more bits, or “bins.”

The video encoder may then select a probability model or “context model” that operates on context to code symbols associated with a block of video data. The probability model indicates a likelihood of a bin having a given binary value (e.g., “0” or “1”). Accordingly, at the encoder, a target symbol may be coded by using the probability model. At the decoder, a target symbol may be parsed by using the probability model. In any case, a video coder may select a probability model by determining a context for the bin.

Context for a bin of a syntax element may include values of related bins of previously coded neighboring syntax elements. As one example, a context for coding a bin of a current syntax element may include values of related bins of previously coded neighboring syntax elements, e.g., on the top and to the left of the current syntax element. The positions from which context is derived may be referred to as a context support neighborhood (also referred to as “context support”, or simply “support”).

For example, with respect to coding the bins of a significance map (e.g., indicating the locations of non-zero transform coefficients in a block of video data), a five point support may be used to define a context model. The five point support may include five transform coefficient positions that neighbor the significance flag currently being coded. In this example, a probability model is identified by Ctx, and Ctx may be defined as a sum of the significant flags in every point of the support, where a significance flag is set to “1” if a corresponding transform coefficient is nonzero or “0” if a corresponding transform coefficient is zero, as shown in Equation (1) below:

$$Ctx = {\sum }_{p ∈ S} ( {coef}_{p} != 0 ) , \\ Ctx = ( Ctx + 1 ) >> 1 \qquad ( 1 )$$

In some examples, Ctx may be an index or offset that is applied to select one of a plurality of different contexts, each of which may correspond to a particular probability model. Hence, in any case, a different probability model is typically defined for each context. After coding the bin, the probability model is further updated based on a value of the bin to reflect the most current probability estimates for the bin. For example, a probability model may be maintained as a state in a finite state machine. Each particular state may correspond to a specific probability value. The next state, which corresponds to an update of the probability model, may depend on the value of the current bin (e.g., the bin currently being coded). Accordingly, the selection of a probability model may be influenced by the values of the previously coded bins, because the values indicate, at least in part, the probability of the bin having a given value.

According to some examples, the positions of the significant coefficients (i.e., nonzero transform coefficients) in a video block may be coded prior to the values of the transform coefficients, which may be referred to as the “levels” of the transform coefficients. The process of coding the locations of the significant coefficients may be referred to as significance map coding. A significance map (SM) includes a two-dimensional array of binary values that indicate locations of significant coefficients.

For example, an SM for a block of video data may include a two-dimensional array of ones and zeros, in which the ones indicate positions of significant transform coefficients within the block and the zeros indicate positions of non-significant (zero-valued) transform coefficients within the block. The ones and zeros are referred to as “significant coefficient flags.” Additionally, in some examples, the SM may include another 2-D array of ones and zeros, in which a one indicates a position of a last significant coefficient within the block according to a scanning order associated with the block, and the zeros indicate positions of all other coefficients within the block. In this case, the one is referred to as the “last significant coefficient flag.” In other examples, a last significant coefficient flag may not be used. Rather, the last significant coefficient in a block may be coded first, prior to coding the rest of the SM.

The remaining bins of the binarized transform coefficients (as well as any other syntax elements being context coded) may then be coded in one or more additional coding passes. For example, during a first pass, a video coder may entropy code the SM. During a second pass, the video coder may entropy code a first bin of the transform coefficient levels. In some examples, the first bin may indicate whether the coefficient level is greater than one, and a second bin may indicate whether the coefficient level is greater than two. Another bin may indicate, in some examples, a sign of a coefficient level. The video coder may continue to perform coding passes until all of the information associated with the transform coefficients of a block is coded. In some examples, the video coder may code the bins of a block of video data using a combination of context adaptive and non-context adaptive coding. For example, for one or more passes, the video coder may use a bypass mode to bypass, or omit, the regular context-adaptive arithmetic coding process. In such instances, a fixed equal probability model may be used to code a bypass coded bin.

In some examples, to improve efficiency and/or simplify implementation, a block of transform coefficients may be divided into sub-sets (which may take the form of a plurality of sub-blocks) for purposes of coding. For example, it may be computationally inefficient for a software or hardware video coder to implement a particular scan (e.g., zigzag, diagonal, horizontal, vertical, or the like) when coding relatively large blocks such as a 32×32 or 64×64 block. In such an example, a video coder may divide a block into a plurality of smaller sub-blocks of a predetermined size (e.g., 8×8 sub-blocks). The video coder may then scan and code each sub-block in sequence until the entire block has been coded.

Parallel processing may be used to increase coding efficiency. As described in this disclosure, parallel processing generally refers performing more than one calculation concurrently. However, in some examples, parallel processing may not include exact temporal coincidence for two processes. Rather, parallel processing may include an overlap or temporal progression such processes are not performed at the same time. Parallel processing may be performed by parallel hardware processing cores or with parallel software threads operating on the same or different processing cores.

However, in order to calculate more than one context for multiple coefficients in parallel, all of the positions in the support must be available for coding. For example, as noted above, a context model for coding a significance flag may be determined by summing all of the significance flags in the support. When determining a context model for coding a significance flag, all of the significance flags in the support must be previously coded (determined) in order for such flags to be available for the summation.

In some instances, one or more significance flags in a particular support may be dependent on other significance flags in the support for determining context. For example, assume a first significance flag A includes in its support a neighboring significance flag B. Accordingly, in order to determine a context model for significance flag A, the significance flag B must be available (coded). Hence, in this example, contexts for significance flags A and B may not be coded in parallel, because the context for significance flag A depends on the significance flag B (e.g., the significance contexts are dependent within the support). A video coder must wait to calculate the context for significance flag A until the significance flag B has been coded, thereby preventing parallel context calculation and reducing or eliminating the efficiency gains associated with parallel processing of contexts.

Aspects of this disclosure relate to calculating context for coding more than one transform coefficient in parallel. For example, in order to calculate contexts for more than one significance flag in parallel, aspects of this disclosure relate to determining a support that avoids context dependencies for two or more significance flags. In some examples, one or more positions in a support may be removed to allow more than one context to be calculated in parallel, thereby introducing one or more “holes” into the support. For example, a significance flag associated with a hole may be skipped and not taken into account for context calculation (i.e., assumed to be zero). Accordingly, there is no need to determine or parse the significance flag in the hole position, which may enable parallel context calculation.

In some examples, according to aspects of this disclosure, holes may be filled with a predetermined and available value. For example, after determining a hole position, a value may be substituted for the hole, which would otherwise be considered to be zero valued. In this way, contexts may still be calculated in parallel using values for all of the positions of the support.

In still other examples, according to aspects of this disclosure, one or more of the support positions may be weighted. For example, in general, all of the positions of a support contribute equally to a context calculation (e.g., each value in the support is counted once). According to aspects of this disclosure, one or more positions of a support may contribute more or less than other positions of the support. In some instances, weighting can be applied to remaining positions of a support that includes holes to compensate for the holes.

While aspects of this disclosure may generally refer to determining context for a transform coefficient, it should be understood that transform coefficients may include associated significance, level, sign, and the like. Accordingly, certain aspects of this disclosure may be particularly relevant to determining context for coding a significance map that includes significance information associated with the transform coefficients.

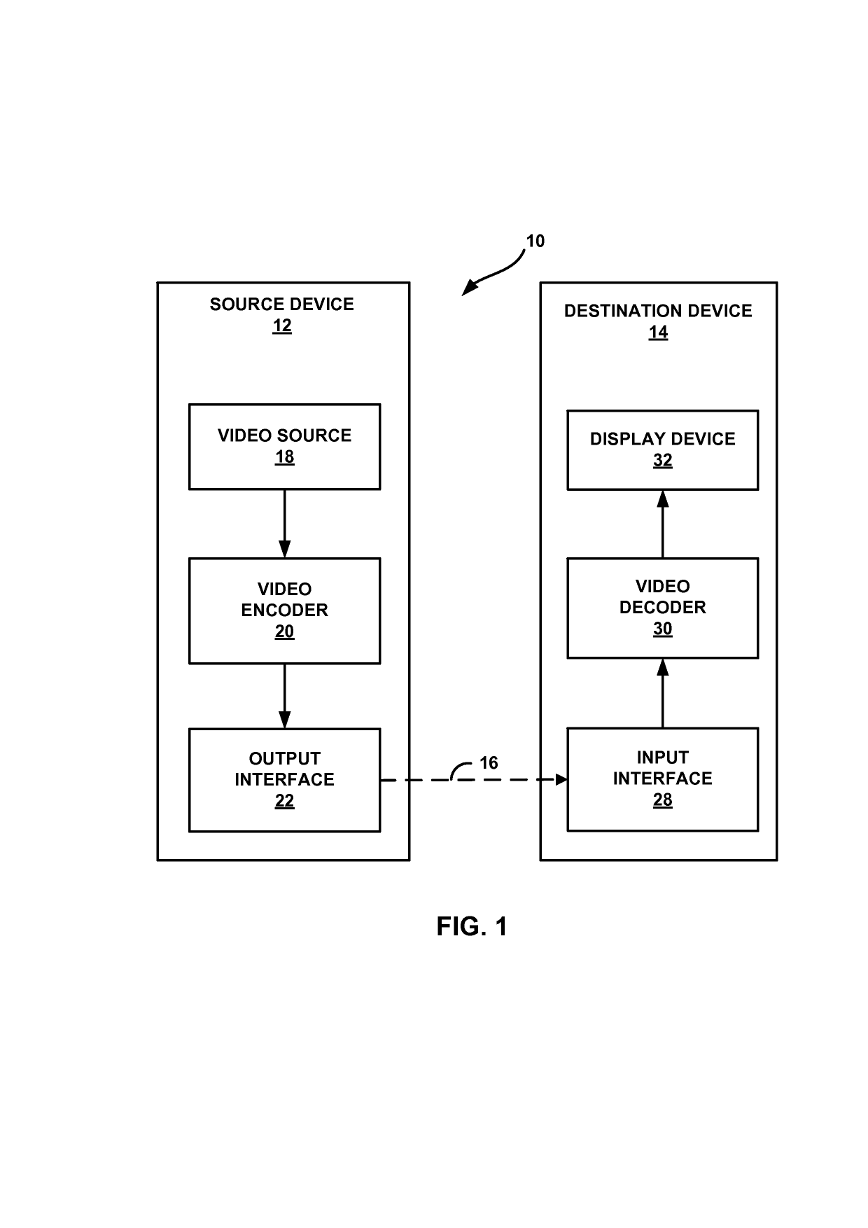

FIG. 1 is a block diagram illustrating an example video encoding and decoding system 10 that may utilize the techniques of this disclosure for performing parallel context calculation. As shown in FIG. 1, system 10 includes a source device 12 that provides encoded video data to be decoded at a later time by a destination device 14. In particular, source device 12 provides the video data to destination device 14 via a computer-readable medium 16. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or the like. In some cases, source device 12 and destination device 14 may be equipped for wireless communication.

Destination device 14 may receive the encoded video data to be decoded via computer-readable medium 16. Computer-readable medium 16 may comprise any type of medium or device capable of moving the encoded video data from source device 12 to destination device 14. In one example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In some examples, encoded data may be output from output interface 22 to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or any other suitable digital storage media for storing encoded video data. In a further example, the storage device may correspond to a file server or another intermediate storage device that may store the encoded video generated by source device 12. Destination device 14 may access stored video data from the storage device via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure are not necessarily limited to wireless applications or settings. The techniques may be applied to video coding in support of any of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes video source 18, video encoder 20, and output interface 22. Destination device 14 includes input interface 28, video decoder 30, and display device 32. In accordance with this disclosure, video encoder 20 of source device 12 may be configured to apply the techniques for performing simplified deblocking decisions. In other examples, a source device and a destination device may include other components or arrangements. For example, source device 12 may receive video data from an external video source 18, such as an external camera. Likewise, destination device 14 may interface with an external display device, rather than including an integrated display device.

The illustrated system 10 of FIG. 1 is merely one example. Techniques for performing parallel context calculation may be performed by any digital video encoding and/or decoding device. Although generally the techniques of this disclosure are performed by a video encoding device, the techniques may also be performed by a video encoder/decoder, typically referred to as a “CODEC.” Moreover, the techniques of this disclosure may also be performed by a video preprocessor. Source device 12 and destination device 14 are merely examples of such coding devices in which source device 12 generates coded video data for transmission to destination device 14. In some examples, devices 12, 14 may operate in a substantially symmetrical manner such that each of devices 12, 14 include video encoding and decoding components. Hence, system 10 may support one-way or two-way video transmission between video devices 12, 14, e.g., for video streaming, video playback, video broadcasting, or video telephony.

Video source 18 of source device 12 may include a video capture device, such as a video camera, a video archive containing previously captured video, and/or a video feed interface to receive video from a video content provider. As a further alternative, video source 18 may generate computer graphics-based data as the source video, or a combination of live video, archived video, and computer-generated video. In some cases, if video source 18 is a video camera, source device 12 and destination device 14 may form so-called camera phones or video phones. As mentioned above, however, the techniques described in this disclosure may be applicable to video coding in general, and may be applied to wireless and/or wired applications. In each case, the captured, pre-captured, or computer-generated video may be encoded by video encoder 20. The encoded video information may then be output by output interface 22 onto a computer-readable medium 16.

Computer-readable medium 16 may include transient media, such as a wireless broadcast or wired network transmission, or storage media (that is, non-transitory storage media), such as a hard disk, flash drive, compact disc, digital video disc, Blu-ray disc, or other computer-readable media. In some examples, a network server (not shown) may receive encoded video data from source device 12 and provide the encoded video data to destination device 14, e.g., via network transmission. Similarly, a computing device of a medium production facility, such as a disc stamping facility, may receive encoded video data from source device 12 and produce a disc containing the encoded video data. Therefore, computer-readable medium 16 may be understood to include one or more computer-readable media of various forms, in various examples.

This disclosure may generally refer to video encoder 20 “signaling” certain information to another device, such as video decoder 30. It should be understood, however, that video encoder 20 may signal information by associating certain syntax elements with various encoded portions of video data. That is, video encoder 20 may “signal” data by storing certain syntax elements to headers of various encoded portions of video data. In some cases, such syntax elements may be encoded and stored (e.g., stored to computer-readable medium 16) prior to being received and decoded by video decoder 30. Thus, the term “signaling” may generally refer to the communication of syntax or other data for decoding compressed video data, whether such communication occurs in real- or near-real-time or over a span of time, such as might occur when storing syntax elements to a medium at the time of encoding, which then may be retrieved by a decoding device at any time after being stored to this medium.

Input interface 28 of destination device 14 receives information from computer-readable medium 16. The information of computer-readable medium 16 may include syntax information defined by video encoder 20, which is also used by video decoder 30, that includes syntax elements that describe characteristics and/or processing of blocks and other coded units, e.g., GOPs. Display device 32 displays the decoded video data to a user, and may comprise any of a variety of display devices such as a cathode ray tube (CRT), a liquid crystal display (LCD), a plasma display, an organic light emitting diode (OLED) display, or another type of display device.

Video encoder 20 and video decoder 30 each may be implemented as any of a variety of suitable encoder or decoder circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. When the techniques are implemented partially in software, a device may store instructions for the software in a suitable, non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined video encoder/decoder (CODEC). A device including video encoder 20 and/or video decoder 30 may comprise an integrated circuit, a microprocessor, and/or a wireless communication device, such as a cellular telephone.

Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 20 and video decoder 30 may operate according to a video compression standard, such as the ITU-T H.264 standard, alternatively referred to as MPEG-4, Part 10, Advanced Video Coding (AVC), or extensions of such standards. The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March, 2005, which may be referred to herein as the H.264 standard or H.264 specification, or the H.264/AVC standard or specification. Other examples of video compression standards include MPEG-2 and ITU-T H.263.

The JCT-VC is working on development of the HEVC standard. While the techniques of this disclosure are not limited to any particular coding standard, the techniques may be relevant to the HEVC standard. The latest Working Draft (WD) of HEVC, Bross, et al., “High Efficiency Video Coding (HEVC) text specification draft 9,” and referred to as HEVC WD9 hereinafter, is available from http://phenix.int-evey.fr/jct/doc_end_user/documents/11 Shanghai/wg11/JCTVC-K1003-v13.zip, as of Jan. 8, 2013.

The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-five intra-prediction encoding modes.

In general, the working model of the HM describes that a video frame or picture may be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive treeblocks in coding order. A video frame or picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs.

Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square (e.g., rectangular) in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

A leaf-CU may include one or more prediction units (PUs). In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

A leaf-CU having one or more PUs may also include one or more transform units (TUs). The transform units may be specified using an RQT (also referred to as a TU quadtree structure), as discussed above. For example, a split flag may indicate whether a leaf-CU is split into four transform units. Then, each transform unit may be split further into further sub-TUs. When a TU is not split further, it may be referred to as a leaf-TU. Generally, for intra coding, all the leaf-TUs belonging to a leaf-CU share the same intra prediction mode. That is, the same intra-prediction mode is generally applied to calculate predicted values for all TUs of a leaf-CU. For intra coding, a video encoder may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, a PU may be collocated with a corresponding leaf-TU for the same CU. In some examples, the maximum size of a leaf-TU may correspond to the size of the corresponding leaf-CU.

Moreover, TUs of leaf-CUs may also be associated with respective quadtree data structures, referred to as residual quadtrees (RQTs). That is, a leaf-CU may include a quadtree indicating how the leaf-CU is partitioned into TUs. The root node of a TU quadtree generally corresponds to a leaf-CU, while the root node of a CU quadtree generally corresponds to a treeblock (or LCU). TUs of the RQT that are not split are referred to as leaf-TUs. In general, this disclosure uses the terms CU and TU to refer to leaf-CU and leaf-TU, respectively, unless noted otherwise.

The HM supports prediction in various PU sizes, also referred to as partition modes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

Following intra-predictive or inter-predictive coding using the PUs of a CU, video encoder 20 may calculate residual data for the TUs of the CU. The PUs may comprise syntax data describing a method or mode of generating predictive pixel data in the spatial domain (also referred to as the pixel domain) and the TUs may comprise coefficients in the transform domain following application of a transform, e.g., a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

Following any transforms to produce transform coefficients, video encoder 20 may perform quantization of the transform coefficients. Quantization generally refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, the video encoder may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan.

After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

Video encoder 20 may further send syntax data, such as block-based syntax data, frame-based syntax data, and group of pictures (GOP)-based syntax data, to video decoder 30, e.g., in a frame header, a block header, a slice header, or a GOP header. The GOP syntax data may describe a number of frames in the respective GOP, and the frame syntax data may indicate an encoding/prediction mode used to encode the corresponding frame.

Video encoder 20 may perform context-based coding (e.g., CABAC) on binarized values (e.g., binarized transform coefficients, symbols, syntax elements, and the like). For example, for each bin, video encoder 20 may select a probability model or “context model” that operates on context to code symbols associated with a block of video data. The probability model indicates a likelihood of a bin having a given binary value (e.g., “0” or “1”).

Video encoder 20 may select a probability model by determining a context for the bin. The positions from which context is derived may be referred to as a context support neighborhood (also referred to as “context support”, or simply “support”). For example, with respect to coding a significance map (e.g., indicating the locations of non-zero transform coefficients in a block of video data), video encoder 20 may use a five-point support neighborhood to define a context model. The five point support may include five transform coefficient positions that spatially neighbor the significance flag currently being coded. Using the support, video encoder 20 may define a probability model as a sum of the significant flags in every point of the support, where a significance flag is set to “1” if a corresponding transform coefficient is nonzero or “0” if a corresponding transform coefficient is zero. In other examples, a different support (e.g., having more or fewer than five points or having five points in a different arrangement) may be used.

In general, video encoder 20 may increase coding efficiency by performing parallel processing of contexts. However, in order to calculate more than one context in parallel, as noted above, all of the positions in the support must be available for coding. Using a support that has context dependencies may impede the ability of video encoder 20 to calculate context for significance flags in parallel, because video encoder 20 may be forced to wait for a support element in the support to finish being coded before determining a context for another support element in the support. This delay may reduce the ability of video encoder 20 to efficiently process significance information and may diminish the benefits that may otherwise be provided by parallel processing.

Aspects of this disclosure relate to calculating context for more than one transform coefficient in parallel. According to aspects of this disclosure, video encoder 20 may determine a support for coding transform coefficient significance information in parallel that does not include context dependencies for two or more significance flags. In some examples, video encoder 20 may remove one or more positions in a support to allow more than one context to be calculated in parallel, thereby introducing one or more “holes” into the support. For example, video encoder 20 may consider significance flags associated with hole positions to be zero-valued, thereby eliminating the need to consider the position during context calculation and enabling parallel context calculation.

In some examples, according to aspects of this disclosure, video encoder 20 may substitute available, predetermined values for one or more positions of a support. For example, after determining hole positions, video encoder 20 may fill the holes with a predetermined value. Video encoder 20 may fill holes using a value from another coefficient from the block, which may or may not already be included in the support. In other examples, video encoder 20 may fill holes using other values that can be derived from neighboring blocks. In this way, contexts may still be calculated in parallel using values for all of the positions of the support.

In still other examples, according to aspects of this disclosure, video encoder 20 may apply weights to one or more of the support positions. For example, video encoder 20 may apply a weighting factor to one or more of a support. Assume, in an example for purposes of illustration, the video encoder 20 applies a weighting factor of 2 to one or more positions in the support. In this example, video encoder 20 may multiply the value associated with the weighted positions by 2 prior to calculating a context. In some instances, video encoder 20 may apply a weighting factor to one or more positions of a support to compensate for holes in the support.

Video decoder 30, upon receiving the coded video data, may perform a decoding pass generally reciprocal to the encoding pass described with respect to video encoder 20. Although generally reciprocal, video decoder 30 may, in some instances, perform techniques similar to those performed by video encoder 20. Video decoder 30 may also rely on syntax elements or other data contained in a received bitstream that includes the data described with respect to video encoder 20.

According to aspects of this disclosure, for example, video decoder 30 may determine a support for coding transform coefficient significance information in parallel that does not include context dependencies for two or more significance flags. In some examples, video decoder 30 may remove one or more positions in a support to allow more than one context to be calculated in parallel, thereby introducing one or more “holes” into the support. Additionally or alternatively, video decoder 30 may substitute available, predetermined values for one or more positions of a support. In still other examples, video decoder 30 may apply weights to one or more of the support positions, as described above with respect to video encoder 20.

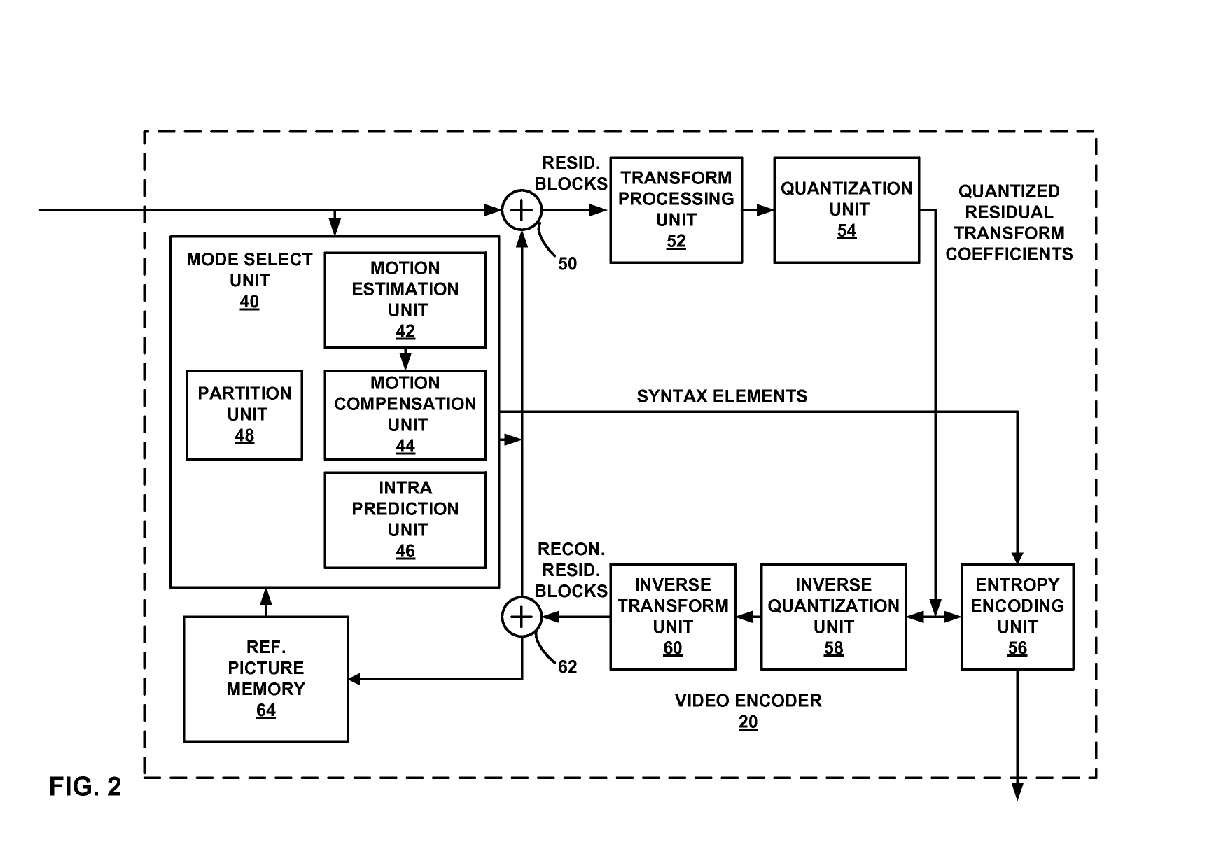

FIG. 2 is a block diagram illustrating an example of a video encoder 20 that may use the techniques of this disclosure for performing parallel context calculation. The video encoder 20 will be described in the context of HEVC coding for purposes of illustration, but without limitation as to other coding standards or methods that may require context-adaptive coding of transform coefficients.

Video encoder 20 may perform intra- and inter-coding of video blocks within video slices. Intra-coding relies on spatial prediction to reduce or remove spatial redundancy in video within a given video frame or picture. Inter-coding relies on temporal prediction to reduce or remove temporal redundancy in video within adjacent frames or pictures of a video sequence. Intra-mode (I mode) may refer to any of several spatial based compression modes. Inter-modes, such as uni-directional prediction (P mode) or bi-prediction (B mode), may refer to any of several temporal-based compression modes.

As shown in FIG. 2, video encoder 20 receives a current video block within a video frame to be encoded. In the example of FIG. 2, video encoder 20 includes mode select unit 40, reference picture memory 64, summer 50, transform processing unit 52, quantization unit 54, and entropy encoding unit 56. Mode select unit 40, in turn, includes motion compensation unit 44, motion estimation unit 42, intra-prediction unit 46, and partition unit 48. For video block reconstruction, video encoder 20 also includes inverse quantization unit 58, inverse transform unit 60, and summer 62. A deblocking filter (not shown in FIG. 2) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal compression. Intra-prediction unit 46 may alternatively perform intra-predictive coding of the received video block relative to one or more neighboring blocks in the same frame or slice as the block to be coded to provide spatial compression. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra or inter, e.g., based on error results, and provides the resulting intra- or inter-coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference picture memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference picture memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Again, motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In general, motion estimation unit 42 performs motion estimation relative to luma components, and motion compensation unit 44 uses motion vectors calculated based on the luma components for both chroma components and luma components. Mode select unit 40 may also generate syntax elements associated with the video blocks and the video slice for use by video decoder 30 in decoding the video blocks of the video slice.

Intra-prediction unit 46 may intra-predict a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

Video encoder 20 forms a residual video block by subtracting the prediction data from mode select unit 40 from the original video block being coded. Summer 50 represents the component or components that perform this subtraction operation.

Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. Wavelet transforms, integer transforms, sub-band transforms or other types of transforms could also be used. In any case, transform processing unit 52 applies the transform to the residual block, producing a block of residual transform coefficients. The transform may convert the residual information from a pixel value domain to a transform domain, such as a frequency domain.

Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy codes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

According to aspects of this disclosure, entropy encoding unit 56 may calculate context for coding information for more than one transform coefficient in parallel. For example, entropy encoding unit 56 may determine that a set of support for selecting a context model to a code a current significant coefficient flag includes at least one significant coefficient flag in a position on which the current significant coefficient flag depends and is not available. That is, entropy encoding unit 56 may determine that a particular set of support includes a context dependency which prevents more than one context from being calculated in parallel. As described in greater detail below, entropy encoding unit 56 may make such a determination based on a relative position of the significance flag being coded in a block and/or sub-block of transform coefficients. The information coded for a transform coefficient may include, for example, information relating to significance, level and sign.

Based on the determination, entropy encoding unit 56 may modify the set of support. In an example, entropy encoding unit 56 may remove one or more positions from the set of support, thereby introducing one or more “holes” into the set of support. Entropy encoding unit 56 may skip a significance flag associated with a hole position. That is, entropy encoding unit 56 may not take the significance flag associated with a hole position into account when determining context for the current significance flag.

In another example, entropy encoding unit 56 may modify the set of support by substituting a predetermined value for one or more positions in the set of support. For example, entropy encoding unit 56 may fill positions that would otherwise not be considered (hole positions) with a predetermined value. In this way, entropy encoding unit 56 may still use all of the positions in the set of support to calculate a context for the current significance flag.

In still another example, entropy encoding unit 56 may modify the set of support by applying weights to one or more positions in the support. For example, as noted above, all positions in a set of support typically contribute equally to a context calculation. According to aspects of this disclosure, entropy encoding unit 56 may modify the set of support by adjusting one or more positions of the set of support to contribute more or less to the context calculation than other positions of the support. In some instances, entropy encoding unit 56 may apply weighting to remaining positions in the set of support to compensate for the holes in the set of support.

After modifying the set of support, entropy encoding unit 56 may calculate a context for the current significant coefficient flag using the modified set of support. In some examples, entropy encoding unit 56 may calculate the sum of all significance flags in the modified support to determine the context for the current significance flag. After calculating the context, entropy encoding unit 56 may apply context-adaptive binary arithmetic coding to code the current significant coefficient flag based on the calculated context. That is, entropy encoding unit 56 may determine a context model based on the determined context and may apply the context model to encode the current significance flag.

As noted above, in some examples, entropy encoding unit 56 may implement the process described above to code more than one significance flag in parallel. For example, by removing context dependencies (e.g., modifying the set of support), entropy encoding unit 56 may calculate contexts for coding multiple significance flags in parallel. As described in greater detail below, the support may be modified to calculate a predetermined number of contexts in parallel. For example, for a given significance flag, a set of support for calculating two contexts in parallel may be different than a set of support for calculating three contexts in parallel. In other examples, entropy encoding unit 56 may apply similar techniques for coding other bins, such as other transform coefficient information (e.g., level and/or sign), or other symbols.

Inverse quantization unit 58 and inverse transform unit 60 apply inverse quantization and inverse transformation, respectively, to reconstruct the residual block in the pixel domain, e.g., for later use as a reference block. Motion compensation unit 44 may calculate a reference block by adding the residual block to a predictive block of one of the frames of reference picture memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference picture memory 64. The reconstructed video block may be used by motion estimation unit 42 and motion compensation unit 44 as a reference block to inter-code a block in a subsequent video frame.

In this manner, video encoder 20 of FIG. 2 represents an example of a video encoder configured to determine that a set of support for selecting a context to code a current significant coefficient flag of a transform coefficient of a block of video data includes at least one significant coefficient flag in a position on which the current significant coefficient flag depends and is not available, based on the determination, modify the set of support, calculate a context for the current significant coefficient flag using the modified set of support, and apply context-adaptive binary arithmetic coding to code the current significant coefficient flag based on the calculated context.

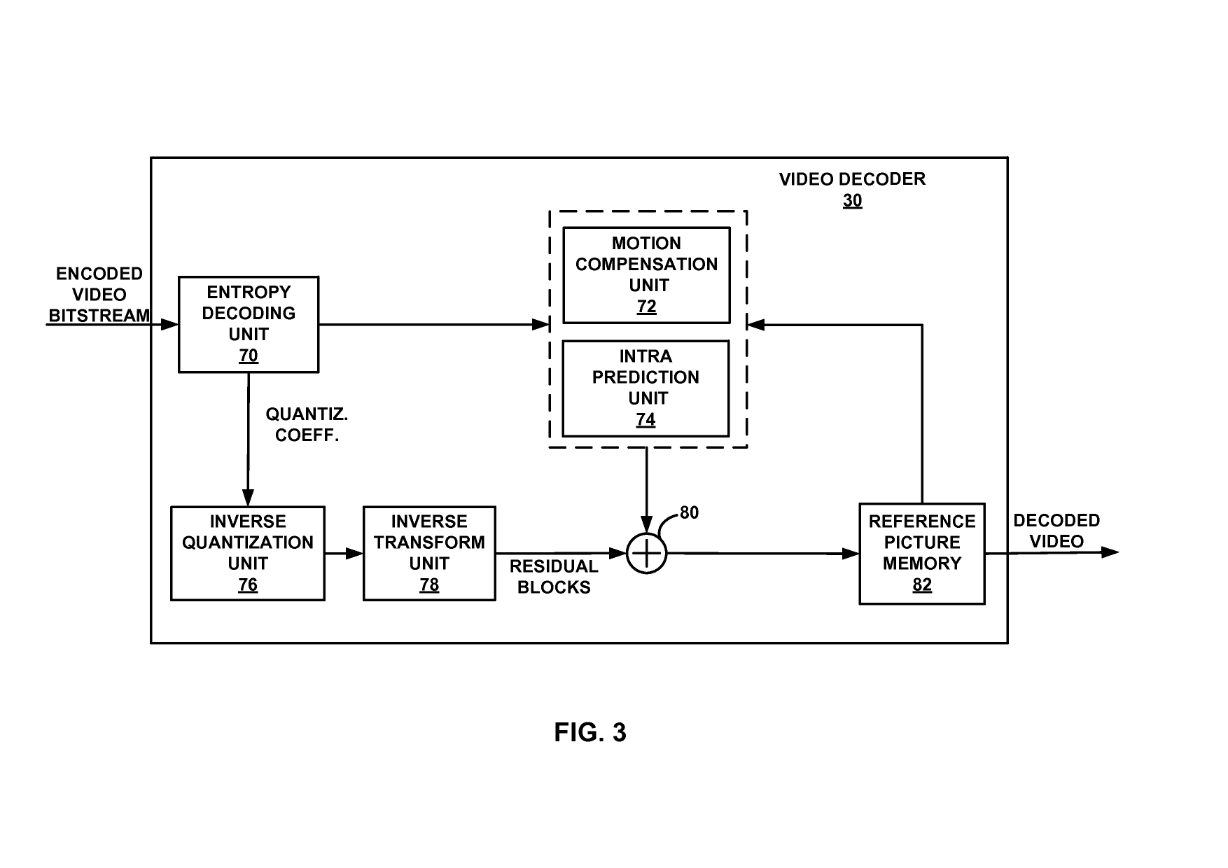

FIG. 3 is a block diagram illustrating an example of video decoder 30 that may implement techniques for performing parallel context calculation. As noted above with respect to FIG. 2, while video decoder 30 is described in the context of HEVC coding for purposes of illustration, the techniques of this disclosure are not limited in this way and may be implemented with other current or future coding standards or methods that may require context-adaptive coding of transform coefficients.

In the example of FIG. 3, video decoder 30 includes an entropy decoding unit 70, motion compensation unit 72, intra prediction unit 74, inverse quantization unit 76, inverse transformation unit 78, reference picture memory 82 and summer 80. During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

For example, by way of background, video decoder 30 may receive compressed video data that has been encapsulated for transmission via a network into so-called “network abstraction layer units” or NAL units. Each NAL unit may include a header that identifies a type of data stored to the NAL unit. There are two types of data that are commonly stored to NAL units. The first type of data stored to a NAL unit is video coding layer (VCL) data, which includes the compressed video data. The second type of data stored to a NAL unit is referred to as non-VCL data, which includes additional information such as parameter sets that define header data common to a large number of NAL units and supplemental enhancement information (SEI). For example, parameter sets may contain the sequence-level header information (e.g., in sequence parameter sets (SPS)) and the infrequently changing picture-level header information (e.g., in picture parameter sets (PPS)). The infrequently changing information contained in the parameter sets does not need to be repeated for each sequence or picture, thereby improving coding efficiency. In addition, the use of parameter sets enables out-of-band transmission of header information, thereby avoiding the need of redundant transmissions for error resilience.

In some examples, video decoder 30 may conform to a predetermined profile and/or level of a video coding standard (such as the emerging HEVC standard or H.264/AVC). For example, in the context of a video coding standard, a profile corresponds to a subset of algorithms, features, or tools and constraints that apply to them. As defined by the H.264 standard, for example, a profile is a subset of the entire bitstream syntax that is specified by the H.264 standard. A level corresponds to the limitations of the decoder resource consumption, such as, for example, decoder memory and computation, which are related to the resolution of the pictures, bit rate, and macroblock (MB) processing rate. A profile may be signaled with a profile idc (profile indicator) value, while a level may be signaled with a level idc (level indicator) value.

According to aspects of this disclosure, entropy decoding unit 70 may calculate context for coding more than one transform coefficient in parallel. For example, entropy decoding unit 70 may determine that a set of support for selecting a context model to a code a current significant coefficient flag includes at least one significant coefficient flag in a position on which the current significant coefficient flag depends and is not available. That is, entropy decoding unit 70 may determine that a particular set of support includes a context dependency which prevents more than one context from being calculated in parallel. As described in greater detail below, entropy decoding unit 70 may make such a determination based on a relative position of the significance flag being coded in a block and/or sub-block of transform coefficients.

Based on the determination, entropy decoding unit 70 may modify the set of support. In an example, entropy decoding unit 70 may remove one or more positions from the set of support, thereby introducing one or more “holes” into the set of support. As noted above, entropy decoding unit 70 may skip a significance flag associated with a hole position.

In another example, entropy decoding unit 70 may modify the set of support by substituting a predetermined value for one or more positions in the set of support. For example, entropy decoding unit 70 may fill positions that would otherwise not be considered (hole positions) with a predetermined value. In this way, entropy decoding unit 70 may still use all of the positions in the set of support to calculate a context for the current significance flag.

In still another example, entropy decoding unit 70 may modify the set of support by applying weights to one or more positions in the support. For example, entropy decoding unit 70 may modify the set of support by adjusting one or more positions of the set of support to contribute more or less to the context calculation than other positions of the support. In some instances, entropy decoding unit 70 may apply weighting to remaining positions in the set of support to compensate for the holes in the set of support.

After modifying the set of support, entropy decoding unit 70 may calculate a context for the current significant coefficient flag using the modified set of support. In some examples, entropy decoding unit 70 may calculate the sum of all significance flags in the modified support to determine the context for the current significance flag. After calculating the context, entropy decoding unit 70 may apply context-adaptive binary arithmetic coding to code the current significant coefficient flag based on the calculated context. That is, entropy decoding unit 70 may determine a probability based on the determined context and may apply the probability model to decode the current significance flag.

As noted above, in some examples, entropy decoding unit 70 may implement the process described above to code more than one significance flag in parallel. For example, by removing context dependencies (e.g., modifying the set of support), entropy decoding unit 70 may calculate contexts for coding multiple significance flag in parallel. As described in greater detail below, the support may be modified to calculate a predetermined number of contexts in parallel. For example, for a given significance flag, a set of support for calculating two contexts in parallel may be different than a set of support for calculating three contexts in parallel. In other examples, entropy decoding unit 70 may apply similar techniques for coding other bins, such as other transform coefficient information (e.g., level and/or sign), or other symbols.

When the video slice is coded as an intra-coded (I) slice, intra prediction unit 74 may generate prediction data for a video block of the current video slice based on a signaled intra prediction mode and data from previously decoded blocks of the current frame or picture.

When the video frame is coded as an inter-coded (i.e., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference picture memory 82.

Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Inverse quantization unit 76 inverse quantizes, i.e., de-quantizes, the quantized transform coefficients provided in the bitstream and decoded by entropy decoding unit 70. The inverse quantization process may include use of a quantization parameter QP_{Y} calculated by video decoder 30 for each video block in the video slice to determine a degree of quantization and, likewise, a degree of inverse quantization that should be applied.

Inverse transform unit 78 applies an inverse transform, e.g., an inverse DCT, an inverse integer transform, or a conceptually similar inverse transform process, to the transform coefficients in order to produce residual blocks in the pixel domain. According to aspects of this disclosure, inverse transform unit 78 may use TUs having the same sizes as corresponding asymmetric SDIP partitions, and thus, different sizes from each other. In other examples, the TUs may each have equal sizes to each other, and thus, potentially be different from the sizes of the asymmetric SDIP partitions (although one of the TUs may be the same size as a corresponding asymmetric SDIP partition). In some examples, the TUs may be represented using a residual quadtree (RQT), which may indicate that one or more of the TUs are smaller than the smallest asymmetric SDIP partition of the current block.

After motion compensation unit 72 generates the predictive block for the current video block based on the motion vectors and other syntax elements, video decoder 30 forms a decoded video block by summing the residual blocks from inverse transform unit 78 with the corresponding predictive blocks generated by motion compensation unit 72. Summer 80 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 82, which stores reference pictures used for subsequent motion compensation. Reference picture memory 82 also stores decoded video for later presentation on a display device, such as display device 32 of FIG. 1.

In this manner, video decoder 30 of FIG. 3 represents an example of a video decoder configured to determine that a set of support for selecting a context to code a current significant coefficient flag of a transform coefficient of a block of video data includes at least one significant coefficient flag in a position on which the current significant coefficient flag depends and is not available, based on the determination, modify the set of support, calculate a context for the current significant coefficient flag using the modified set of support, and apply context-adaptive binary arithmetic coding to code the current significant coefficient flag based on the calculated context.

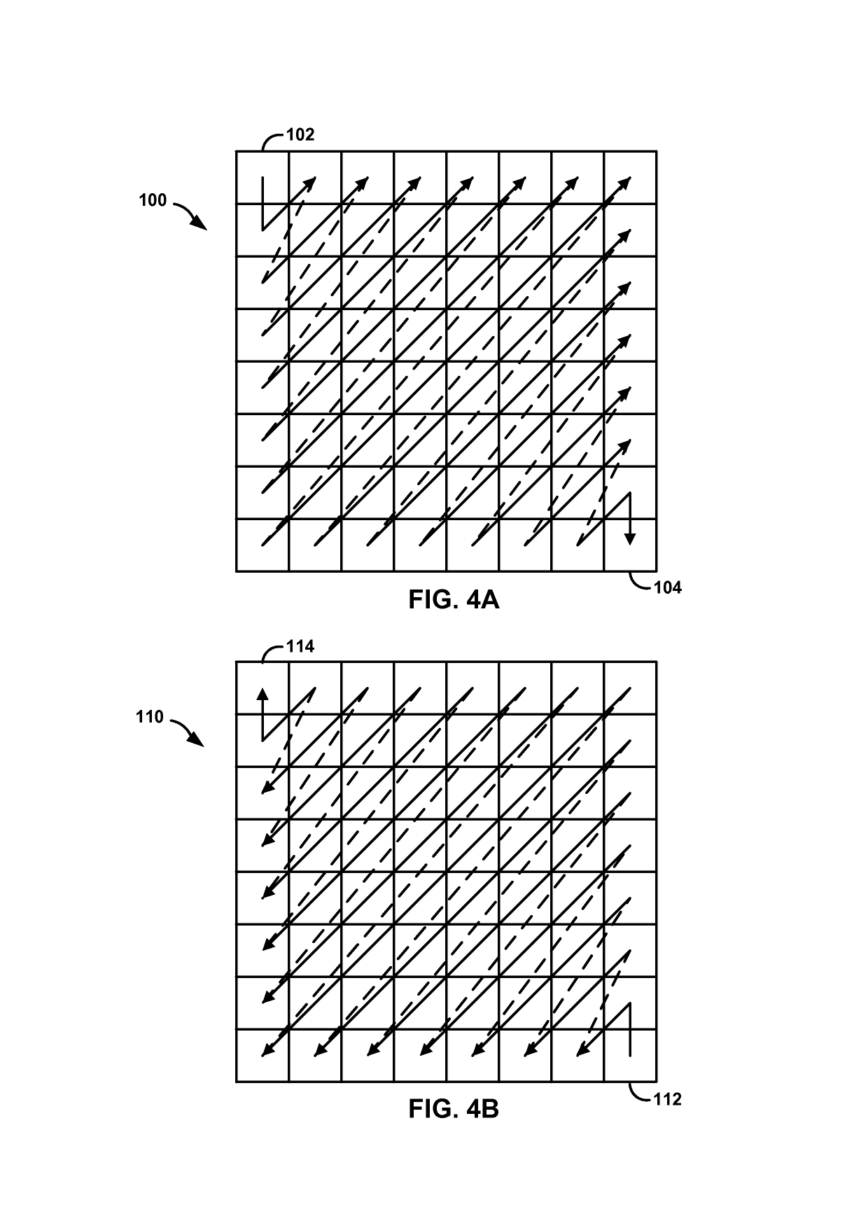

FIGS. 4A and 4B generally illustrate diagonal scan patterns for scanning transform coefficients associated with a block of video data during coding. For example, the scan patterns may be used by a video encoder (such as video encoded 20 when serializing a two-dimensional array of transform coefficients. In another example, the scan patterns may be used by a video decoder (such as video decoder 30), in a reciprocal manner, when reconstructing a block of video data from a received serialized array of coded transform coefficients.

For example, FIG. 4A illustrates a forward diagonal scan pattern 100 for scanning transform coefficients of a block of video data (e.g., transform coefficients associated with a TU). In general, the forward diagonal scan pattern 100 traverses the block at a 45 degree angle from left to right and from bottom to top. In the example shown in FIG. 4A, a first coefficient 102 is a DC component positioned at the upper left corner of the block, while a last coefficient 104 to be scanned is positioned at the bottom right corner of the block.

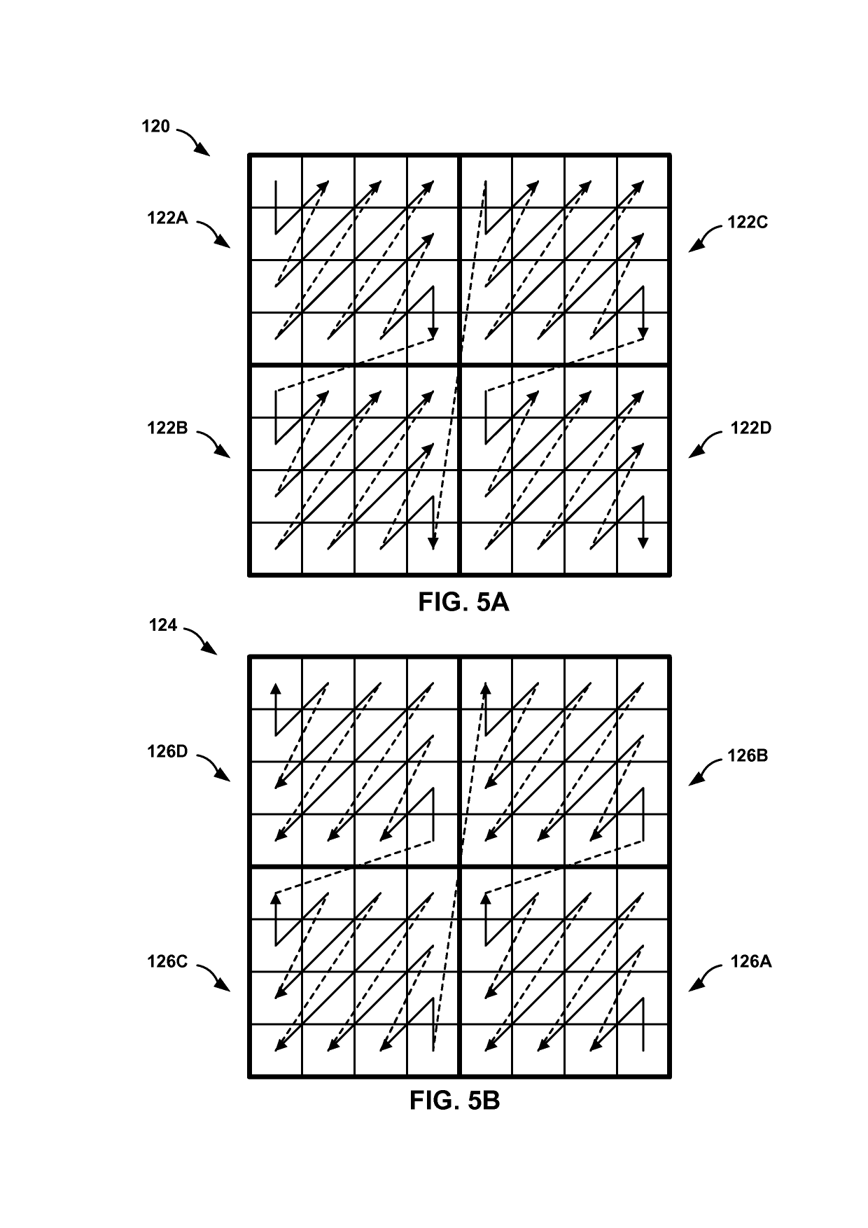

FIG. 4B illustrates a reverse diagonal scan pattern 110 for scanning transform coefficients of a block of video data (e.g., transform coefficients associated with a TU). In general, the reverse diagonal scan pattern 110 traverses the block at a 45 degree angle from right to left and from top to bottom. That is, in the example shown in FIG. 5B, a first coefficient 112 is a DC component positioned at the lower right corner of the block, while a last coefficient 114 to be scanned is positioned at the top left corner of the block.

In some examples, a video coder (such as video encoder 20 or video decoder 30) may code transform coefficients using the scans shown in FIGS. 4A and 4B in more than one coding pass. For example, the video coder may code the positions of significant (i.e., nonzero) transform coefficients prior to coding the levels of the transform coefficients. In such examples, the video coder may use a harmonized scan for the scanning passes. That is, the video coder may scan the significance map and transform coefficients in the same manner (using the same scan pattern and direction). In other examples, the video coder may scan a significance map in the opposite direction of transform coefficient levels.

The scan patterns shown in FIGS. 4A and 4B may be used by a video encoder (such as video encoder 20) and a video decoder (such as video decoder 30) in a reciprocal manner. For example, video encoder 20 may use the scans shown in FIGS. 4A and 4B to serialize a two-dimensional array of transform coefficients. Reciprocally, video decoder 30 may use the scans shown in FIGS. 4A and 4B to reproduce a two-dimensional array of transform coefficients from a serialized array.

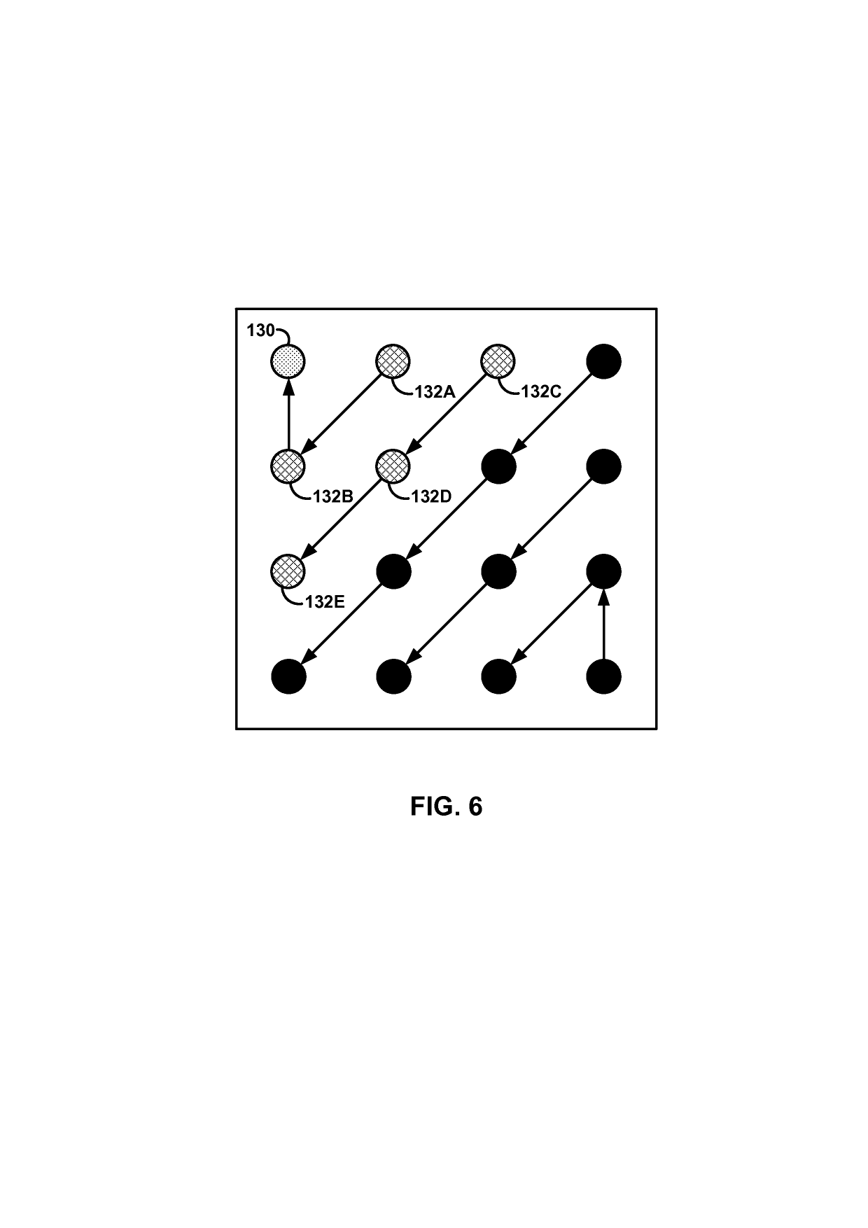

In any case, as described in greater detail below with respect to FIGS. 6-17B, when performing context adaptive coding, the video coder may determine context for each transform coefficient position along scan patterns 100 and 110. According to aspects of this disclosure, the video coder may implement a context support neighborhood that allows context for more than one transform coefficient to be calculated in parallel. In some examples, the video coder may remove one or more positions from the support. In other examples, the video coder may substitute values for one or more positions from the support. In still other examples, the video coder may apply weights to one or more positions from the support.

It should be understood that the scan patterns shown in FIGS. 4A and 4B are provided for purposes of illustration only. For example, while FIGS. 4A and 4B illustrate a diagonal scan pattern, a video coder may implement a variety scan patterns having a variety of other orientations (e.g., a zig-zag pattern, a horizontal pattern, a vertical pattern, an adaptive scan order, and the like). In addition, different components associated with transform coefficients (e.g., significance, sign, level, and the like) may be scanned using patterns of different orientations and/or directions.

FIGS. 5A and 5B generally illustrate dividing a block of transform coefficients associated with a block of video data into sub-sets in the form of sub-blocks. As noted above, in some examples, a video coder (such as video encoder 20 or video decoder 30) may implement the sub-block structure shown in FIGS. 5A and 5B to reduce hardware and/or software requirements associated with processing relatively large blocks.

With respect to FIG. 5A, the video coder may divide block 120 into sub-blocks 122A, 122B, 122C, and 122D (collectively, sub-blocks 122) while coding block 120. In the example shown in FIG. 5A, first sub-block 122A includes a 4×4 block of transform coefficients positioned in the upper left corner of block 120, a second sub-block 122B includes a 4×4 block of transform coefficients positioned in the lower left corner of block 120, a third sub-block 122C includes a 4×4 block of transform coefficients positioned in the upper right corner of block 120, and a fourth sub-block 122D includes a 4×4 block of transform coefficients positioned in the lower right corner of block 120.

In a similar manner as described with respect to FIG. 5A, the video coder may divide block 124 of FIG. 5B into sub-blocks 126A, 126B, 126C, and 126D while coding block 124. In the example shown in FIG. 5B, first sub-block 126A includes a 4×4 block of transform coefficients positioned in the lower right corner of block 124, a second sub-block 226B includes a 4×4 block of transform coefficients positioned in the upper right corner of block 124, a third sub-block 126C includes a 4×4 block of transform coefficients positioned in the lower left corner of block 124, and a fourth sub-block 126D includes a 4×4 block of transform coefficients positioned in the upper left corner of block 124.

The video coder may code sub-blocks 122 and 126 sequentially. That is, with respect to FIG. 5A, the video coder may code all information associated with transform coefficients (e.g., significance, sign, and level) for one sub-block before coding another sub-block. In this example, the video coder may code all bins associated with sub-block 122A before coding sub-block 122B. The video coder may then code sub-block 122C and 122D. Likewise, with respect to FIG. 5B, the video coder may code all bins associated with sub-block 126A before coding sub-block 126B, sub-block 126C, and sub-block 126D.

In other examples, the video coder may code each bin of data for the entire block 120 and 124 before coding another bin. For example, with respect to FIG. 5A, the video coder may code a significance map for each of sub-blocks 122. The video coder may then code each bin of the transform coefficient levels for each of sub-blocks 122, and so on. Likewise, with respect to FIG. 5B, the video coder may code a significance map for each of sub-blocks 126, followed by transform coefficient levels for each of sub-blocks 126, and so on.

In some examples, the video coder may use a unified scan for scanning transform coefficients. For example, with respect to FIG. 5A, the video coder may code a significance map and coefficient levels of transform coefficients using the same diagonal scan. In other examples, the video coder may code different bins of transform coefficients (e.g., significance, sign, levels, and the like) using scans having different orientations. For example, the video coder may map absolute values of transform coefficient levels maps of each square (or rectangular) 8×8 block and larger onto an ordered set (e.g., vector) of 4×4 sub-blocks by using a forward diagonal, vertical, horizontal, or zig-zag scan. The video coder may then code transform coefficient levels inside each 4×4 sub-block using a reverse diagonal, vertical, horizontal, or zig-zag scan having the opposite orientation as the forward scan. To facilitate a reverse (or inverse) scan shown in FIG. 5B, the video coder may first identify a last significant coefficient of block 124. After identifying the last significant coefficient, the video coder may apply the scan shown in FIG. 5B.

Accordingly, for each 4×4 block, the video coder may code a significant_coeffgroup_flag, and if there is at least one nonzero coefficient in the sub-block this flag is set to one, otherwise it is equal to zero. If significant_coeffgroup_flag is nonzero, the video coder may scan each 4×4 sub-block and code significant_coeff_flag for every coefficient indicating significance of the coefficient, as well as the transform coefficient levels. Instead of explicit signaling, the significant_coeffgroup_flag can be implicitly derived, using neighbor 4×4 sub-block flags or if 4×4 block contains last coefficient or DC.

In any event, as noted above, aspects of this disclosure generally relate to calculating contexts for coding transform coefficients in parallel. According to some aspects of this disclosure, a video coder may determine a support for determining context based on a transform coefficient's position in a sub-block (such as sub-blocks 122 or 126). In such examples, the video coder may use a first support for coding a first significance flag in sub-block 122A and a second, different support for coding a second, different significance flag in sub-block 122A.

In some examples, the supports used for coding significance flags in each sub-block may be consistent between sub-blocks. That is, the support used for determining context for a particular transform coefficient position in sub-block 122A may be the same as the support used for determining context for the same relative position of a transform coefficient in sub-block 122B. Accordingly, a video coder may determine a support based on a relative position of the significance flag being coded in a sub-block.

In other examples, as described below, the same set of support may be used for the entire blocks 120 or 124. That is, in some examples, the set of support may not change based on the relative position of the significance flag being coded. Such examples may be more computationally simplistic, as a video coder does not need to determine a position of the bin being coded to determine a support for context calculation.

While the examples shown in FIGS. 5A and 5B generally illustrate a diagonal scan pattern, the video coder may implement a variety of other scan patterns when coding transform coefficients. Examples include a zig-zag pattern, an adaptive scan order, a horizontal pattern, a vertical pattern, and the like. In addition, while the examples shown in FIGS. 5A and 5B illustrate 8×8 blocks of transform coefficients with 4×4 sub-blocks, it should be understood that the techniques of this disclosure may be applied to blocks of other sizes, as well as sub-blocks of other sizes. If the video coder uses the same sub-block size for all TUs of a frame (or slice), gains may be achieved in a hardware implementation due to the uniformity achieved with the sub-block sizes. A uniform sub-block size is not necessary, however, to carry out the techniques of this disclosure.

FIG. 6 generally illustrates a context support neighborhood for calculating context. For example, FIG. 6 generally illustrates dependency in significance context calculation within a context support neighborhood when performing parallel context calculation. In the example shown in FIG. 6, a current or “target” significance flag (the significance flag currently being coded) 130 may be coded using context derived from support 132A, 132B, 132C, 132D, and 132E (collectively, support 132). For example, as noted above with respect to Equation (1), a video coder (such as video encoder 20 or video decoder 30) may determine a context Ctx based on a sum of the significance flags in every position of support 132, where a significance flag is “1” if the corresponding transform coefficient is nonzero.

In some examples, support 132 may not be suitable for calculating context for more than one transform coefficient in parallel. For example, using support 132 shown in FIG. 6 may impede the ability of the video coder to calculate contexts for more than one significance flag in parallel, because all data in the support 132A-E must be available (e.g., already coded) when calculating contexts. That is, to calculate a significance context for a particular position, it may be necessary to parse the significance flags of all positions within the support. Such parsing may introduce a delay if there is a requirement to calculate significance contexts of two coefficients in parallel, because the significance flags may be positioned adjacent to each other in scanning order.

In an example for purposes of illustration, the video coder may attempt to determine contexts for coding two significance flags in parallel in scanning order. For example, the video coder may attempt to calculate context for coding current significance flag 130 in parallel with the significance flag of the preceding position in scanning order, i.e., the significance flag in support position 132B. However, in this example, the video coder must wait for the significance flag in support position 132B to finish coding before determining the context for current significance flag 130, because current significance flag depends on support position 132B. That is, the value of the significance flag in support position 132B must be known (coded) before the value can be used, for example, in the context model summation shown in Equation (1). The delay associated with this context dependency reduces the ability of the video coder to efficiently process significance information.

The five point support 132 shown in FIG. 6 is merely one example. In other examples, supports having more or fewer than five positions may be used for context-adaptive coding. In addition, as shown and described with respect to the figures below, other supports may have differently located positions for determining context. While FIG. 6 is described with respect to context coding significance flags, similar techniques may be applied for context coding other bins (e.g., transform coefficient levels, signs, or other symbols).

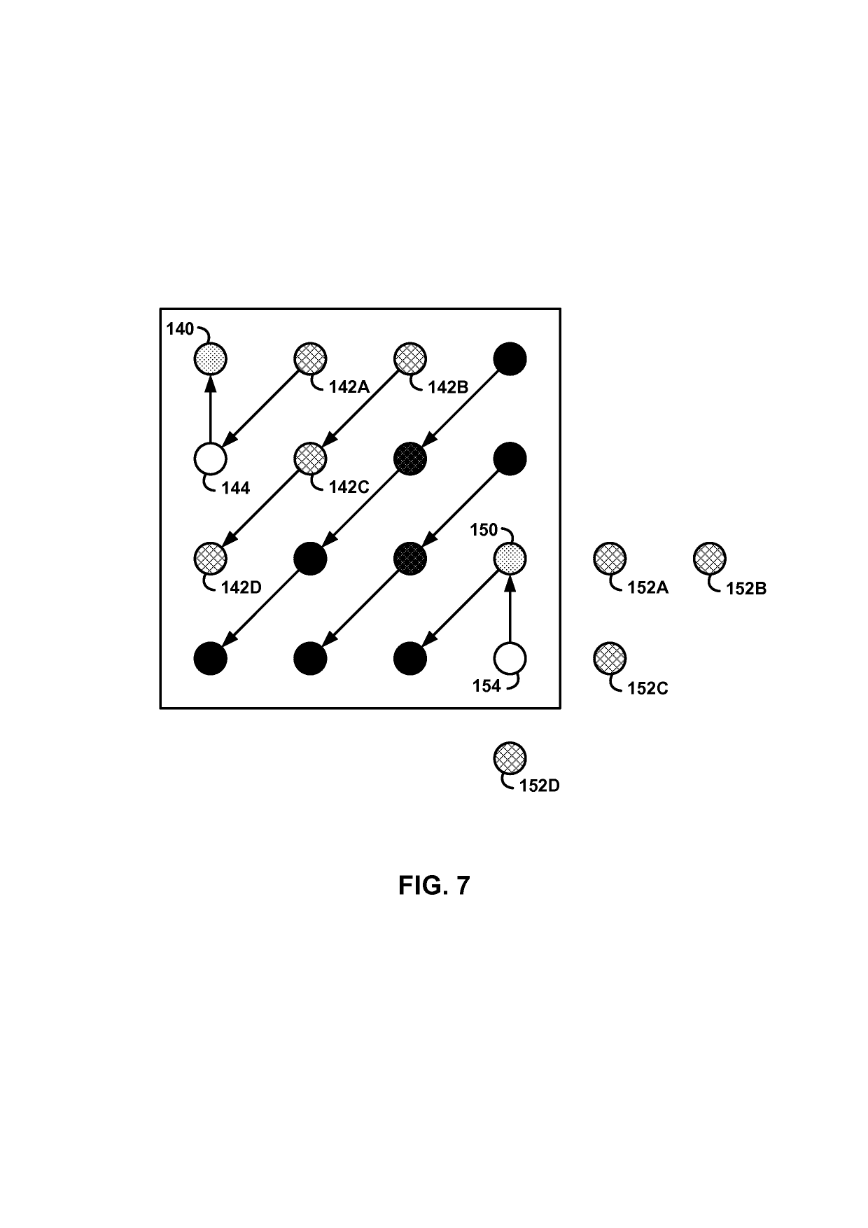

FIG. 7 generally illustrates a context support neighborhood for calculating more than one context in parallel, according to aspects of this disclosure. In the example shown in FIG. 7, a current or “target” significance flag 140 may be coded using context derived from support 142A, 142B, 142C, and 142D (collectively, support 142). In addition, according to aspects of this disclosure, hole 144 is introduced into the support. Likewise, target significance flag 150 may be coded using context derived from support 152A, 152B, 152C, and 152D (collectively, support 152), with hole 154 being introduced into the support.

To resolve the context calculation dependency described with respect to FIG. 6, holes 144 and 154 may be introduced to supports 142 and 152, respectively, thereby removing a position from support 142 and a position from support 152. The significance flags associated with holes 144 and 154 may be skipped and not taken into account for the context calculation (i.e., assumed to be zero). Accordingly, there is no need to parse the significance flags in the position of holes 144 and 154 when calculating context for target significance flag 140 and significance flag 150, respectively.

Using so-called “holes” in this way may enable parallel context calculation. For example, with respect to target significance flag 140, a video coder (such as video encoder 20 or video decoder 30) may derive a context model by calculating a sum of the significance flags from support 142, but not from hole 144. Accordingly, the significance flag associated with hole 144 does not need to be available when determining the context model, and the video coder may calculate the context for coding the significance flag associated with hole 144 in parallel with context for coding target significance flag 140. The same process may be used to calculate context for target significance flag 150 and the significance flag associated with hole 154 in parallel.

In some examples, the support shape depends on the position of the significance flag being calculated to allow for better parallel processing. That is, the video coder may determine an appropriate support based on the relative position of the target significance flag being processed (as well as, in some examples, the number of contexts being calculated in parallel, as described in greater detail below). Accordingly, the support for determining context for target significance flag 140 may be different than that for a significance flag in position 142A of support 142. In other examples, the same support may be used for calculating all contexts.

FIG. 7 generally illustrates support for calculating two contexts in parallel. However, in some examples, as described in greater details below, a video coder may calculate more than two contexts in parallel. In such examples, the video coder may add holes into support 142 and/or support 152 to remove context dependencies and enable additional parallel context calculations. Accordingly, according to aspects of this disclosure, a video coder may add holes conditionally, depending on the number of contexts are calculated in parallel.

Again, the supports 142 and 152 shown in FIG. 7 (and elsewhere in this disclosure) are provided as examples only. That is, in other examples, supports having more or fewer than five positions (or positions in different locations) may be used in accordance with the techniques described above. Moreover, the position of holes in a set of support described above may be dependent on the scan order. That is, FIG. 7 illustrates a reverse diagonal scan pattern. In other examples, an alternative scan pattern may be used (e.g., vertical, horizontal, zig-zag, and the like). In such examples, the location of holes may be alternatively arranged in order to support parallel context calculation in accordance with the techniques of this disclosure. While FIG. 7 is described with respect to context coding significance flags, similar techniques may be applied for context coding other bins (e.g., transform coefficient levels, signs, or other symbols).

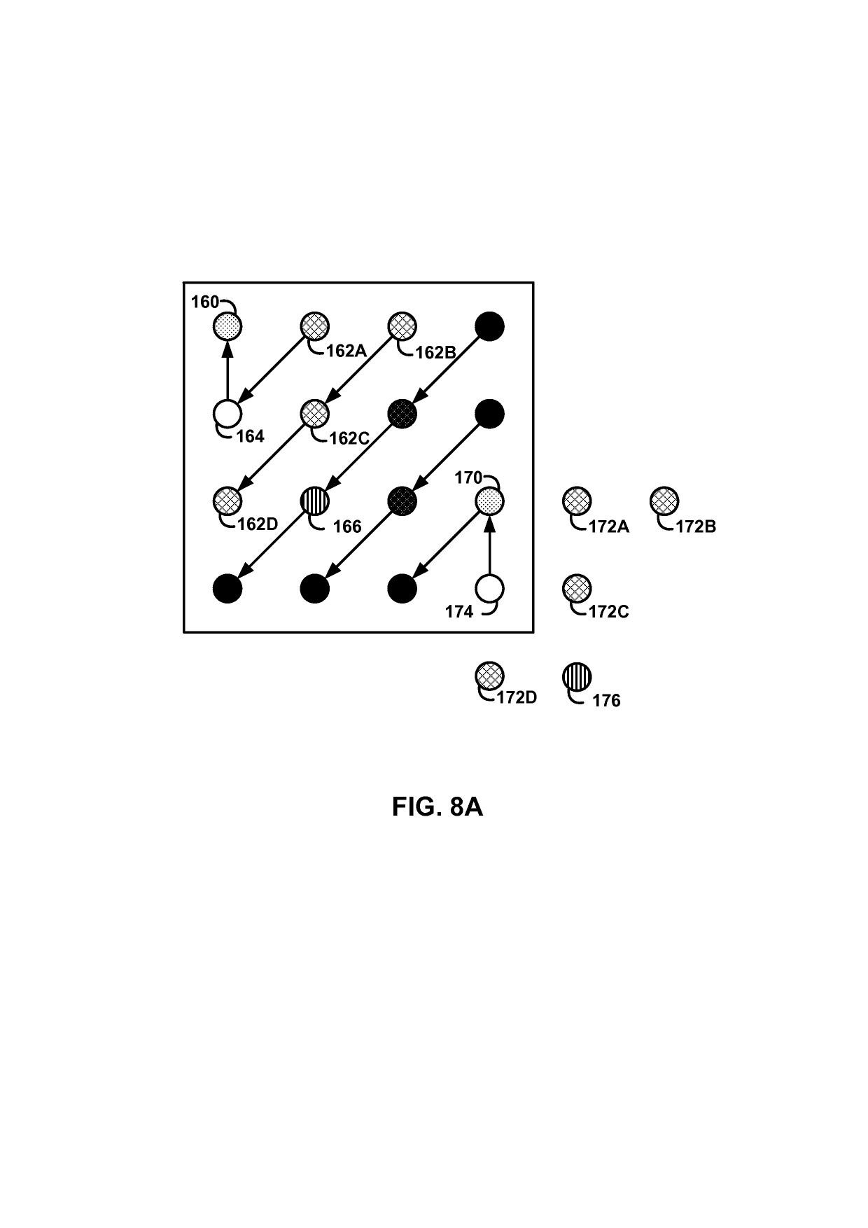

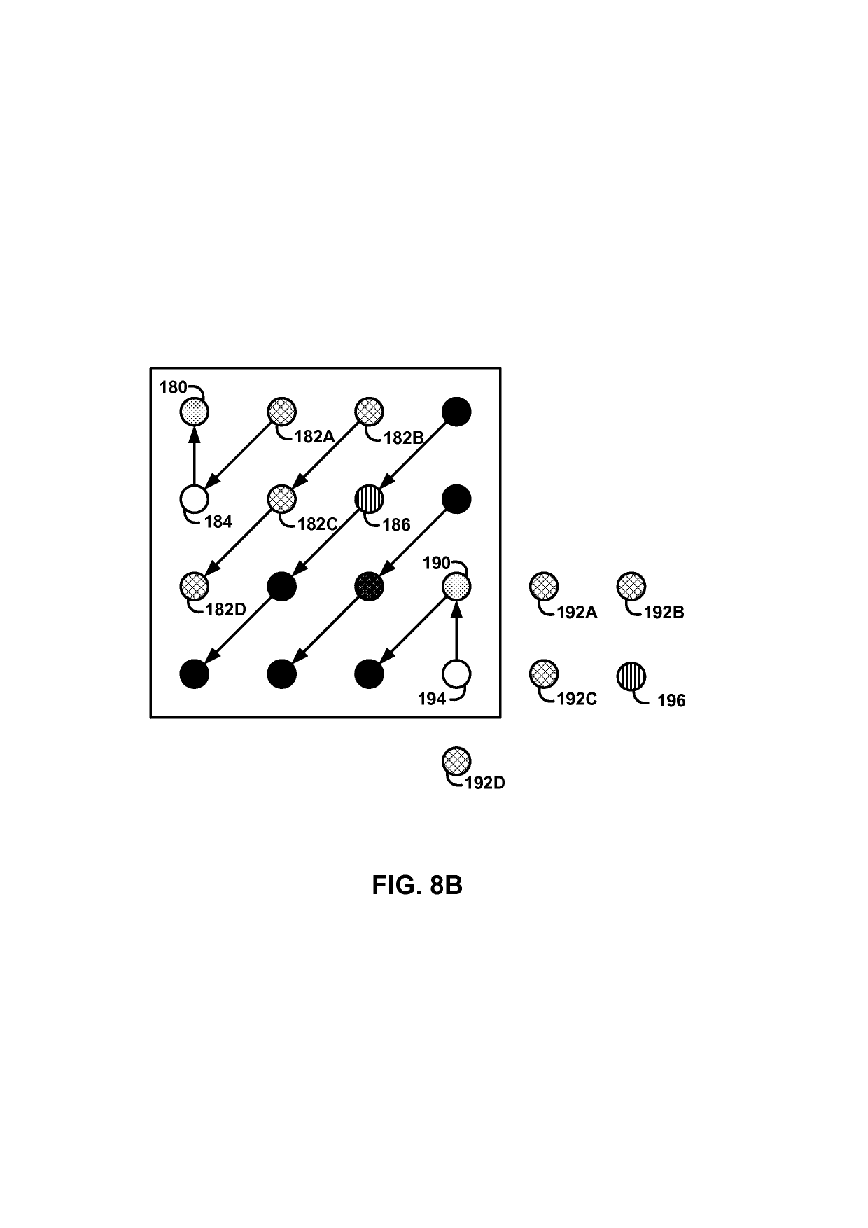

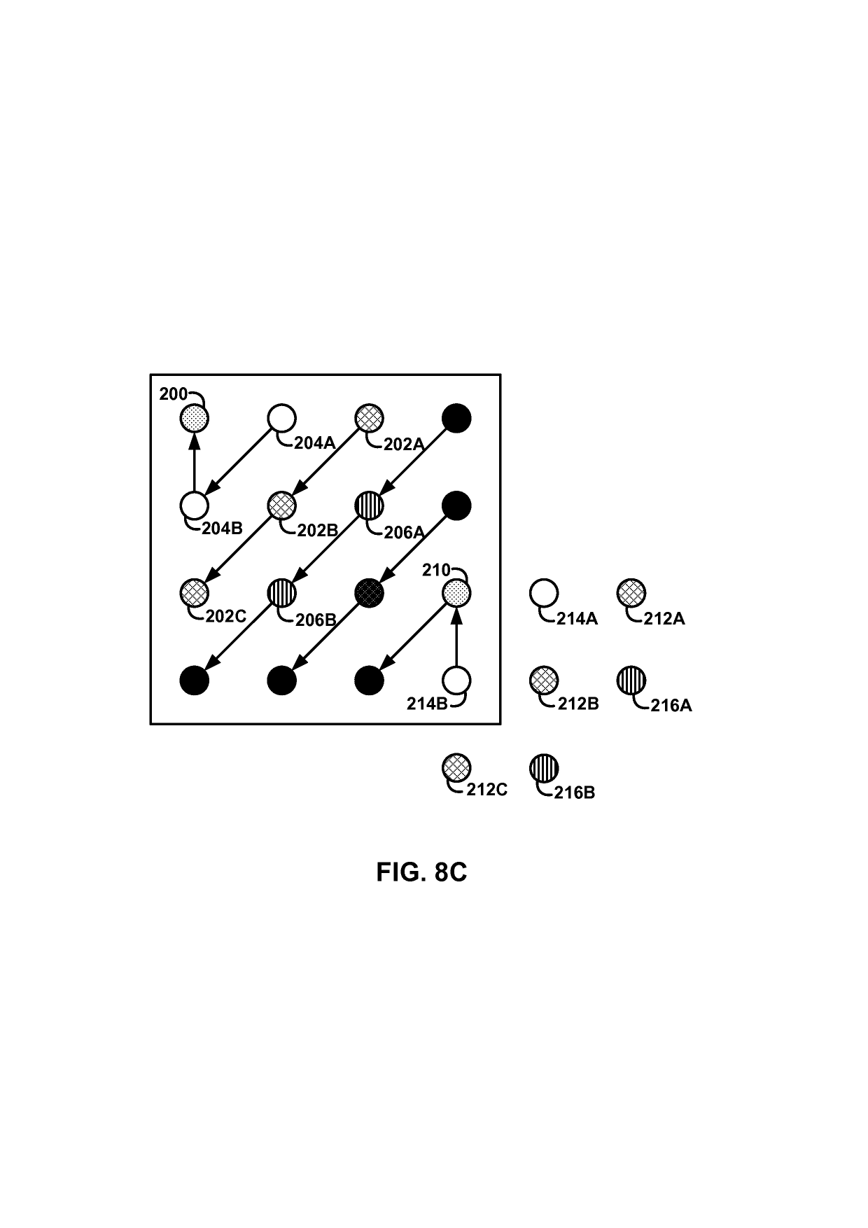

FIGS. 8A-8C generally illustrate context support neighborhoods for calculating more than one context in parallel, according to aspects of this disclosure. In the example shown in FIG. 8A, target significance flag 160 may be coded using context derived from support 162A, 162B, 162C, and 162D (collectively, support 162). As described above, hole 164 may be introduced into the support to allow for parallel context calculation. However, rather than just removing the significance flag associated with hole 164 from the support and assuming a zero value, according to aspects of this disclosure, the value of position 166 may be substituted for the value at hole 164. Accordingly, support 162 effectively includes positions 162A, 162B, 162C, 162D and 166. In this way, the value associated with hole 164 may be filled with the value of the coefficient at position 166 when calculating context for target significance flag 160.

Similarly, target significance flag 170 may be coded using context derived from support 172A, 172B, 172C, and 172D (collectively, support 172), as well as position 176. For example, as described above, hole 174 may be introduced into an initial set of support, but may be filled with the value of position 176. Accordingly, support 172 effectively includes positions 172A, 172B, 172C, 172D and 176. That is, values from positions 172A, 172B, 172C, 172D and 176 may be used to determine context for target significance flag 170.

FIGS. 8B and 8C illustrate additional examples of filling holes for context calculation, according to aspects of this disclosure. For example, in the example shown in FIG. 8B, target significance flag 180 may be coded using context derived from support 182A, 182B, 182C, and 182D (collectively, support 182), as well as position 186. For example, hole 184 may be introduced into an initial set of support, but may be filled with the value of position 186. Accordingly, support 182 effectively includes positions 182A, 182B, 182C, 182D and 186. That is, values from positions 182A, 182B, 182C, 182D and 186 may be used to determine context for target significance flag 180. Likewise, support for deriving context for target 190 may include positions 192A, 192B, 192C, 192D, and 196, with the value of hole 194 being replaced with the value of position 196.

FIG. 8C illustrates yet another example introducing holes into a set of support, e.g., due to dependencies that may otherwise break parallelism. The example shown in FIG. 8C includes holes for calculating three contexts in parallel. For example, target significance flag 200 may be coded using context derived from support 202A, 202B, 202C. In addition, values associated with holes 204A and 204B may be replaced with values from positions 206A and 206B. Accordingly, the support for significance flag 200 includes 202A, 202B, 202C, as well as 206A and 206B. That is, values from positions 202A, 202B, 202C, 206A and 206B may be used to determine context for target significance flag 200. Likewise, support for deriving context for target 210 may include positions 212A, 212B, 212C, 216A, and 216B, with the values of holes 214A and 214B being replaced with the values of positions 216A and 216B.

Accordingly, rather than just removing points from a set support and assuming a zero value for them to enable parallel context calculation, FIGS. 8A-8C illustrate examples in which holes are replaced with values from another transform coefficient of the block being coded (which may or may not be part of the support already). In other examples, another value for substitution may be derived, for example, from information associated with another block (e.g., a neighboring block or sub-block).

Adding positions to a support versus simply creating a hole may increase entropy coding efficiency. For example, a support having relatively more positions may provide a better estimate of the value of the target significance flag. That is, a more accurate context model may be determined using a relatively larger set of support, thereby improving entropy coding efficiency.

In this manner, FIGS. 8A-8C represents various examples of retrieving a value for a significant coefficient flag from a transform coefficient outside a set of initial support defining a context model to code a current significant coefficient, and using the retrieved value to substitute for a value for a significant coefficient flag in a position on which the current significant coefficient flag depends. The supports shown in FIGS. 8A-8C are provided as examples, and the techniques may be applied using supports having more or fewer positions (or positions in different locations).

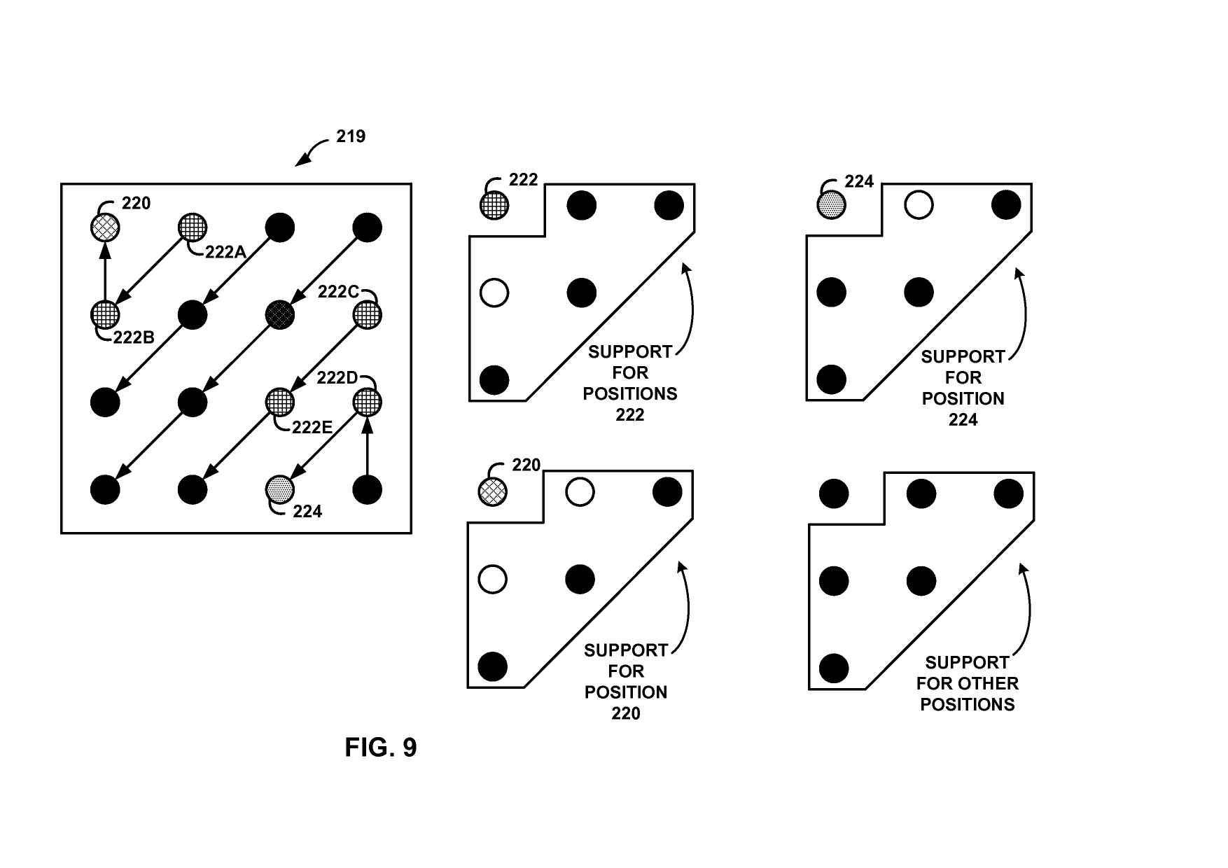

FIG. 9 illustrates an example of introducing holes into support based on the location of the significance flag being coded, according to aspects of this disclosure. For example, FIG. 9 illustrates three different sets of support having holes that may be used by a video coder (such as video encoder 20 or video decoder 30) to calculate context for coding significance flags in a block (or sub-block) of transform coefficients 219 in parallel. That is, the video coder may use the supports shown in FIG. 9 to calculate three contexts in parallel.

In the example of FIG. 9, the video coder may calculate context for significance flag 220 in parallel with two other contexts using a five point set of support (as shown in the example of FIG. 6) having two holes, with one hole positioned to the right of significance flag 220 and one hole positioned below significance flag 220. The video coder may calculate context for significance flags 222A, 222B, 222C, 222D, and 222E (collectively, flags 222) in parallel with two other contexts using a five point set of support having a single hole positioned below significance flags 222. The video coder may calculate context for significance flag 224 in parallel with two other contexts using a five point set of support having a hole positioned to the right of significance flag 224. The video coder may calculate context for all other significance flags in parallel with two other contexts using a five point set of support with no holes.

Using the various sets of support shown in FIG. 9 to calculate contexts may allow the video coder to code more than one context in parallel. For example, the position based sets of support shown in FIG. 9 may allow the three contexts to be calculated in parallel of the significance flags of block 219. That is, in an example for purposes of illustration, the video coder may calculate a context for coding significance flag 220 in parallel with the contexts associated with the two preceding significance flags in scan order.

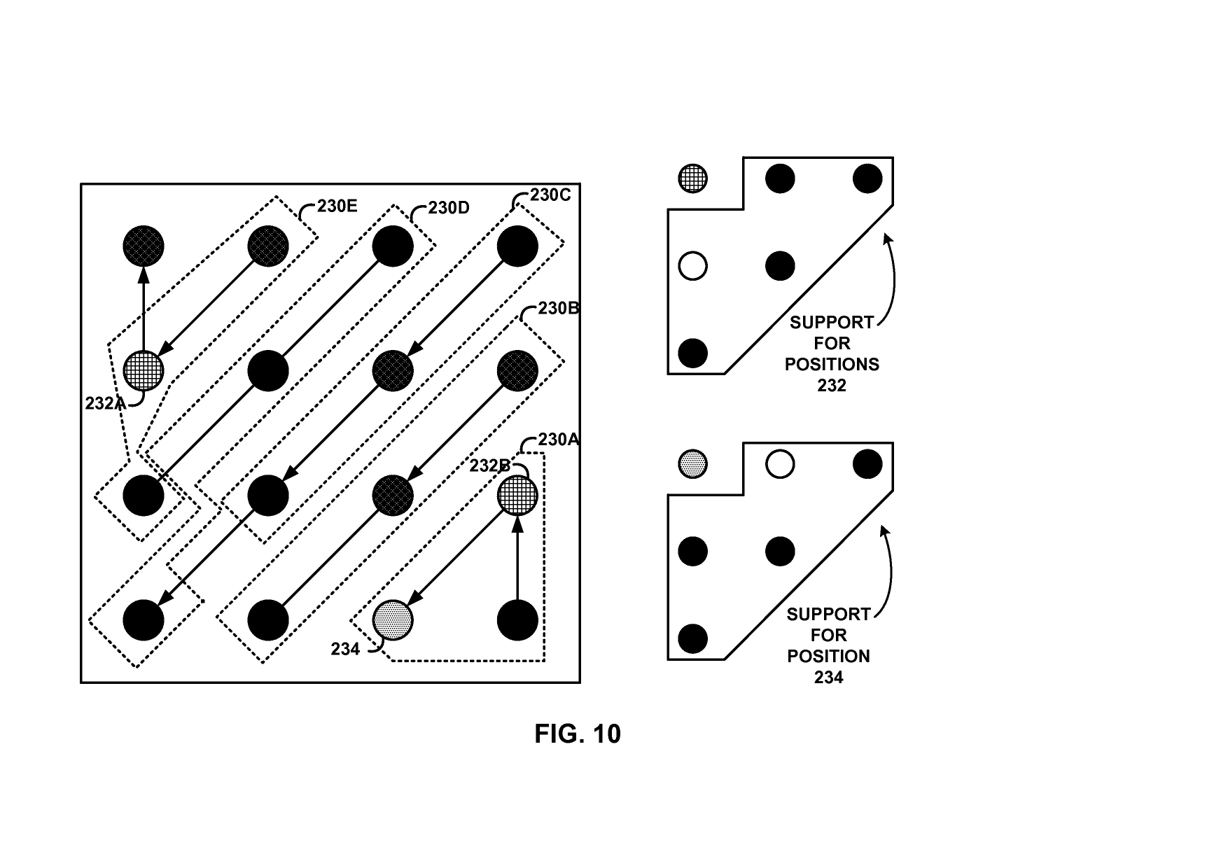

The supports shown in FIG. 9 may be used regardless of which contexts of significance flags of block 219 are being calculated in parallel. That is, any three contexts may be calculated in parallel, however, each position may be associated with a particular set of support. Accordingly, the video coder may have to check one or more conditions (e.g., such as the locations of the significance flags for the context being calculated) in order to apply the appropriate support to each position. As described below with respect to FIG. 10, the number conditions to be checked may be reduced by assuming that predetermined groups of contexts (e.g., every three contexts) are calculated in parallel, followed by parsing the significance flags for the groups.

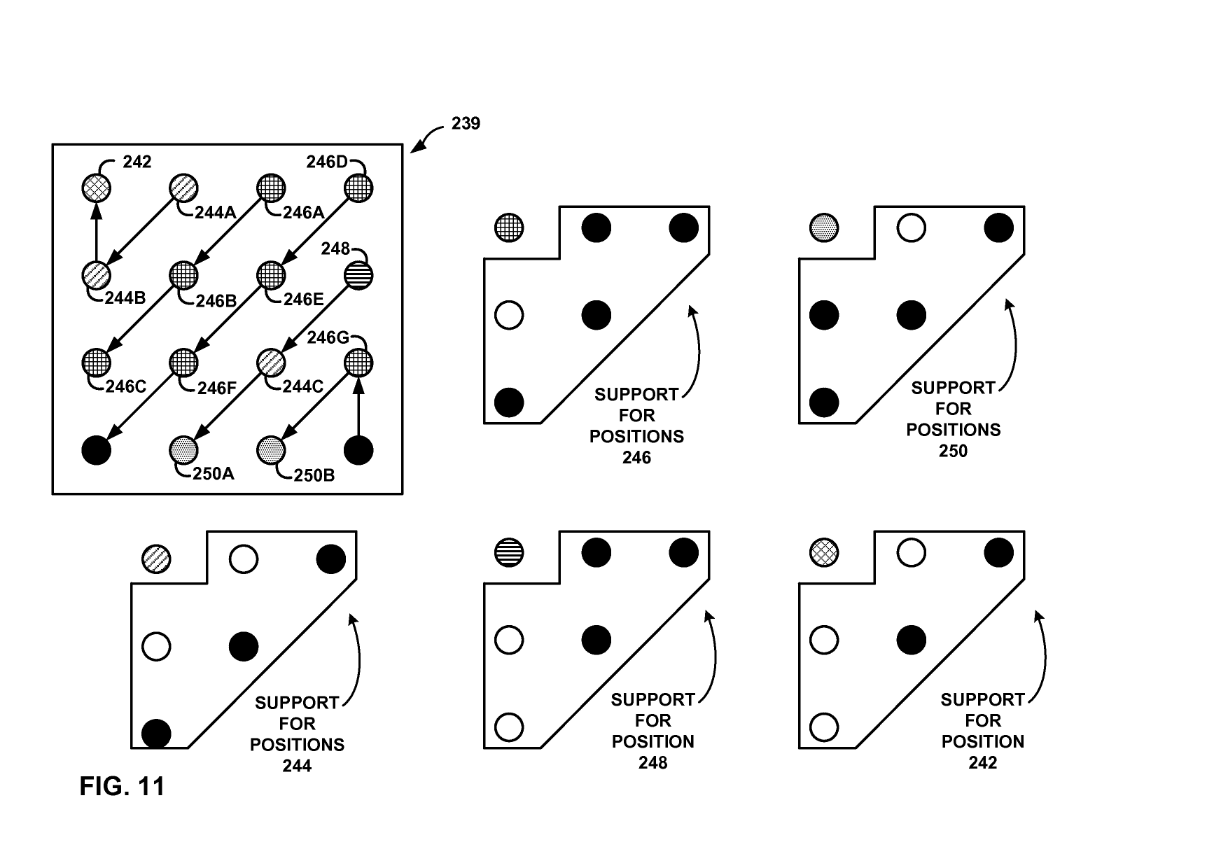

It should be understood that the sets of supports shown in FIG. 9 are provided as examples, and that other sets of support may be used to calculate contexts in parallel. The sets of support used to calculate contexts in parallel may depend, for example, on the number of transform coefficients being coded (e.g., the size of the block or sub-block), the number of contexts being calculated in parallel, the grouping of contexts being calculated in parallel, and the like. For example, while FIG. 9 illustrates sets of support that may be used to calculate three contexts in parallel, other sets of support (with a different arrangement of holes) may be used to calculate two, four (as shown and described, for example, with respect to FIG. 11), or another number of contexts in parallel.

In some examples, as described above with respect to FIGS. 8A-8C one or more of the holes shown in FIG. 9 may be filled with a substitute value. That is, rather than just removing a significance flag associated with a hole and assuming a zero value, according to aspects of this disclosure, a value associated with another position in the block (or sub-block) or another value (e.g., a value from a neighboring block, a value of a significant_coeffgroup_flag syntax element, or the like) may be substituted for the value at the hole. The supports shown in FIG. 9 are provided as examples, and the techniques may be applied using supports having more or fewer positions (or positions in different locations).

FIG. 10 illustrates an example of introducing holes into support based on a group of significance contexts being calculated in parallel, according to aspects of this disclosure. For example, FIG. 10 illustrates five groups of significance flags (dashed boxes 230A-230E, collectively, groups 230), with each group having three associated significance flags in scanning order. FIG. 10 also illustrates two different sets of support having holes that may be used by a video coder (such as video encoder 20 or video decoder 30) to calculate context for the groups of significance flags 230.

According to aspects of this disclosure, the video coder may calculate contexts for each of the three significance flags in each of the groups 230 in parallel. That is, the video coder may calculate contexts for all three significance flags in group 230A in parallel. The video coder may then calculate contexts for all three significance flags in group 230B in parallel, and so on, until the video coder has coded the entire block.

The groups shown in FIG. 10 are merely one example, and the video coder may form other groupings for context calculation. For example, the video coder may group the first two coefficients in scanning order and group the last two coefficients in scanning order, while also grouping the remaining coefficients in four groups of three coefficients. Other configurations with groupings of two, three, or more significance flags for parallel context calculation are also possible.

Grouping significance flags for parallel context calculation may reduce the computational complexity associated with calculating contexts. For example, rather than determining the position of each significance flag when calculating context, the video coder may determine the group being coded. Each of groups 230 may each have predetermined supports for each position in the group. Accordingly, the video coder may apply the appropriate supports based on the group being coded.

The video coder may use a five point support (as shown in the example of FIG. 6) to calculate the contexts of the significance flags shown in FIG. 10. However, the video coder may insert holes into some supports based on the group 230 being coded to enable parallel context calculation. For example, the video coder may insert a hole into a support when calculating context for significance flags 232A and 232B. In this example, as shown in FIG. 10, the video coder may insert a hole in the support below positions 232A and 232B when calculating contexts for group 230A and 230E. Accordingly, the video coder may calculate the context for positions 232A and 232B in parallel with the significance flags positioned directly below positions 232A and 232B (due to the removal of the context dependency).

In addition, the video coder may insert a hole into a support when calculating context for position 234. In this example, as shown in FIG. 10, the video coder may insert the hole to the right of position 234 when calculating the context for group 230A. Accordingly, the video coder may calculate the context for position 234 in parallel with the significance flag positioned to the right of position 234 (due to the removal of the context dependency).

In some examples, as described above with respect to FIGS. 8A-8C one or more of the holes shown in FIG. 10 may be filled with a substitute value. That is, rather than just removing a significance flag associated with a hole and assuming a zero value, according to aspects of this disclosure, a value associated with another position in the block (or sub-block) or another value (e.g., a value from a neighboring block, a value of a significant_coeffgroup_flag syntax element, or the like) may be substituted for the value at the hole. The supports shown in FIG. 10 are provided as examples, and the techniques may be applied using supports having more or fewer positions (or positions in different locations).

FIG. 11 illustrates another example of introducing holes into support based on the location of the significance flag being coded, according to aspects of this disclosure. For example, FIG. 11 illustrates five different sets of support having holes that may be used by a video coder (such as video encoder 20 or video decoder 30) to calculate context for coding significance flags in a block (or sub-block) of transform coefficients 239 in parallel. That is, the video coder may use the supports shown in FIG. 11 to calculate four contexts in parallel.

The video coder may calculate context for significance flag 242 in parallel with three other contexts using a five-point set of support (as shown in the example of FIG. 6) having three holes, with one hole positioned to the right of significance flag 242 and two holes positioned below significance flag 242. The video coder may calculate context for significance flags 244A, 244B, and 244C (collectively, significance flags 244) in parallel with three other contexts using a five-point set of support having a hole positioned below significance flags 244 and a hole positioned to the right of significance flags 244. The video coder may calculate context for significance flags 246A, 246B, 246C, 246D, 246E, 246F, and 246G (collectively, significance flags 246) in parallel with three other contexts using a five-point set of support having a hole positioned below each of significance flags 246. The video coder may calculate context for significance flag 248 in parallel with three other contexts using a five point set of support having two holes positioned below significance flag 248. The video coder may calculate context for significance flags 250A and 250B (collectively, significance flags 250) in parallel with three other contexts using a five point set of support having a hole positioned to the right of significance flag 220. The video coder may calculate context for the remaining significance flags of block 239 in parallel with three other contexts using a five point set of support with no holes.

As noted above, the position based sets of support shown in FIG. 11 may allow the video coder to calculate contexts of four significance flags of block 239 in parallel. That is, in an example for purposes of illustration, the video coder may calculate a context for coding significance flag 242 in parallel with the contexts associated with the three preceding significance flags in scan order.

The supports shown in FIG. 11 may be used regardless of which contexts of significance flags of block 239 are being calculated in parallel. That is, any four contexts may be calculated in parallel, however, each position may be associated with a particular set of support. Accordingly, the video coder may have to check the location of the significance flag being coded in order to apply the appropriate support when calculating context. As described below with respect to FIG. 12, the complexity associated with the position checking may be reduced by assuming that predetermined groups of contexts (e.g., every four contexts) are calculated in parallel, followed by parsing the significance flags for the groups.

In some examples, as described above with respect to FIGS. 8A-8C one or more of the holes shown in FIG. 11 may be filled with a substitute value. That is, rather than just removing a significance flag associated with a hole and assuming a zero value, according to aspects of this disclosure, a value associated with another position in the block (or sub-block) or another value (e.g., a value from a neighboring block, a value of a significant_coeffgroup_flag syntax element, or the like) may be substituted for the value at the hole. The supports shown in FIG. 11 are provided as examples, and the techniques may be applied using supports having more or fewer positions (or positions in different locations).

FIG. 12 illustrates an example of introducing holes into support based on a group of significance contexts being calculated in parallel, according to aspects of this disclosure. For example, FIG. 12 illustrates four groups of significance flags (dashed boxes 259A-259D, collectively groups 259), with each group having four associated significance flags in scanning order. FIG. 12 also illustrates four different sets of support having holes that may be used by a video coder (such as video encoder 20 or video decoder 30) to calculate context for the groups of significance flags 259.

According to aspects of this disclosure, the video coder may calculate contexts for each of the four significance flags in each of the groups 259 in parallel. That is, the video coder may calculate contexts for all four significance flags in group 259A in parallel. The video coder may then calculate contexts for all four significance flags in group 259B in parallel, and so on, until the video coder has coded the entire block.

The groups shown in FIG. 12 are merely one example, and the video coder may form other groupings for context calculation. For example, as noted above with respect to FIG. 10, the video coder may group different numbers of significance flags in a given block to form groups of different sizes for parallel context calculation. As such, other configurations with groupings of two, three, or more significance flags for parallel context calculation are also possible.

Grouping significance flags for parallel context calculation may reduce the computational complexity associated with calculating contexts. For example, rather than determining the position of each significance flag when calculating context, the video coder may determine the group being coded. Each of groups 259 may each have predetermined supports for each position in the group. Accordingly, the video coder may apply the appropriate supports based on the group being coded.

The video coder may use a five-point support (as shown in the example of FIG. 6) to calculate the contexts of the significance flags shown in FIG. 10. However, the video coder may insert holes into some supports based on the group 259 being coded to enable parallel context calculation. For example, as shown in FIG. 12, the video coder may insert a hole into the five-point support to the right of significance flag 260 and two holes in the five point support below significance flag 260 when calculating contexts for group 259D. In addition, the video coder may insert a hole into the five point support below significance flags 262A-262D when calculating contexts for groups 259A, 259B, and 259C. The video coder may also insert two holes into the five point support below significance flag 264 when calculating contexts for group 259A. The video coder may also insert a hole into the five point support to the right of significance flag 266 when calculating contexts for group 259A.

Using the holes in the manner shown in FIG. 12 may allow for parallel context calculation by removing context dependencies, as described above. In other examples, any number of significance contexts may be calculated in parallel expanding this concept to add additional conditional holes to supports.

In some examples, as described above with respect to FIGS. 8A-8C one or more of the holes shown in FIG. 12 may be filled with a substitute value. That is, rather than just removing a significance flag associated with a hole and assuming a zero value, according to aspects of this disclosure, a value associated with another position in the block (or sub-block) or another value (e.g., a value from a neighboring block, a value of a significant_coeffgroup_flag syntax element, or the like) may be substituted for the value at the hole. The supports shown in FIG. 12 are provided as examples, and the techniques may be applied using supports having more or fewer positions (or positions in different locations).

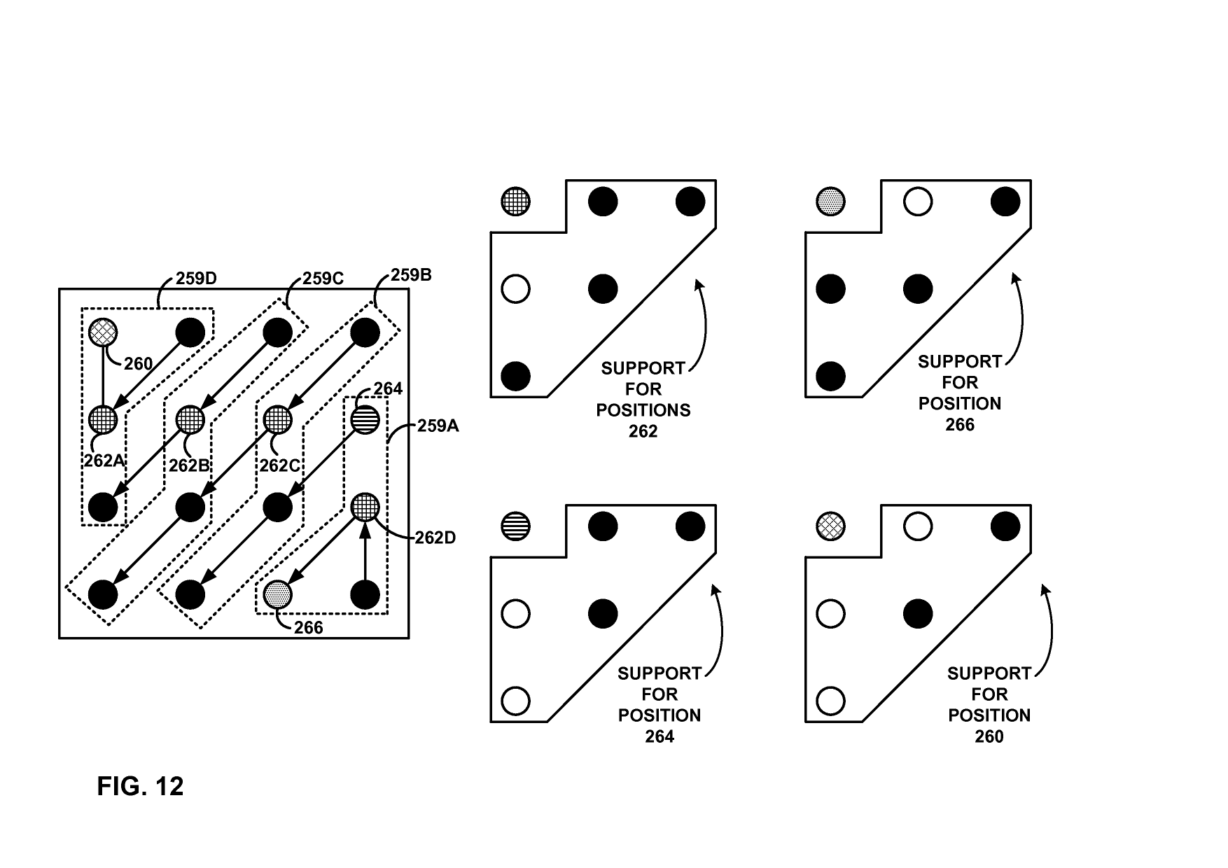

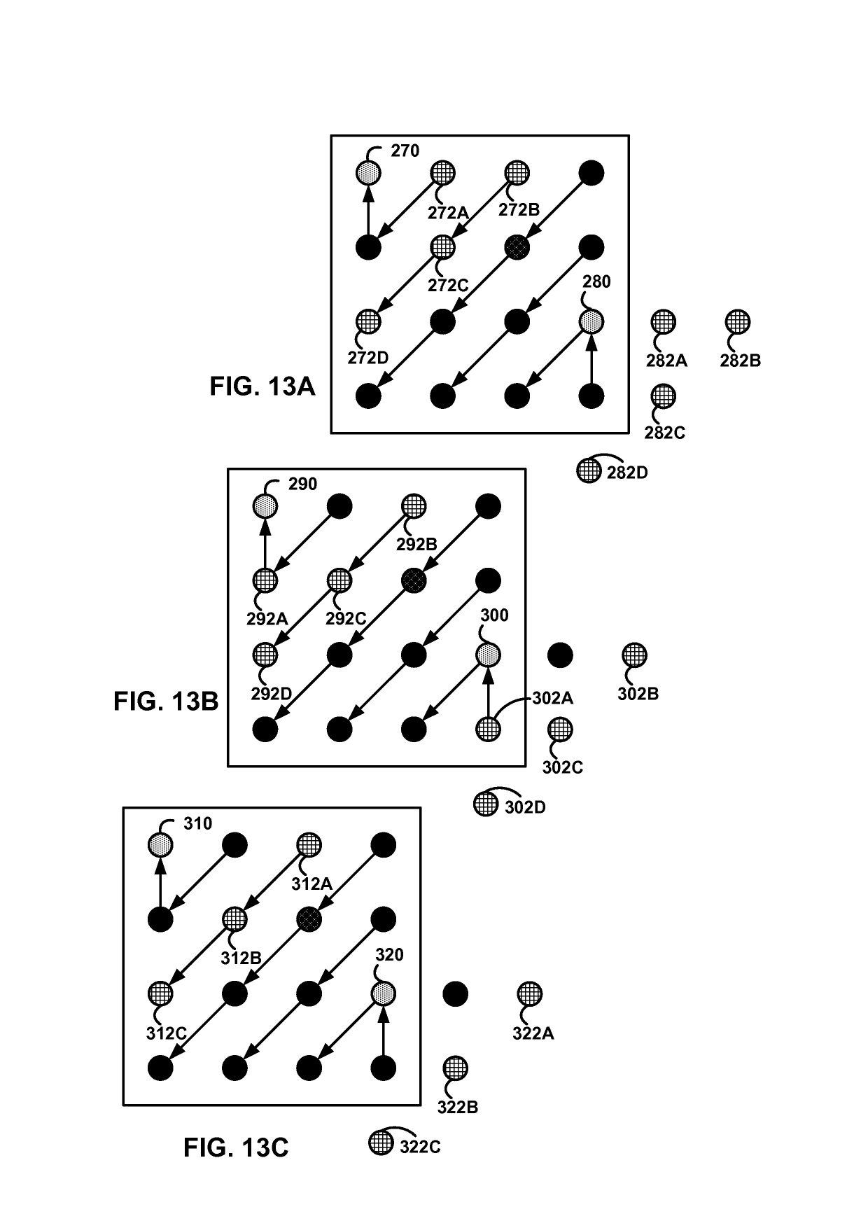

FIGS. 13A-13C illustrates examples of supports having holes (relative to the five point support described above) that are not position-based, according to aspects of this disclosure. That is, while certain examples described above include introducing holes into a support based on the location of the significance flag being coded, the example supports shown in FIGS. 13A-13C may be used to calculate contexts for all positions in a block (or sub-block), without respect to the position being coded.

For example, with respect to FIG. 13A, a video coder (such as video encoder 20 or video decoder 30) may calculate a context for coding target significance flag 270 using support 272A, 272B, 272C, and 272D (collectively, support 272). Relative to the five-point set of support described with respect to FIG. 6, support 272 does not include the position below target significance flag 270. The video coder may use support having the same positions relative to a target significance flag for calculating context for every other position in the block. As an example, the video coder may calculate context for coding target significance flag 280 using support 282A, 282B, 282C, and 282D (collectively, support 282).

Supports 272 and 282 may be used to enable parallel calculation of contexts. For example, the video coder may calculate contexts for a target significance flag and a significance flag that precedes the target significance flag in scanning order. While holes may not be necessary for parallel context calculation for every position in the block, using a single set of support for calculating contexts for an entire block (e.g., one that is not position-based) may reduce the computational complexity associated with calculating contexts. That is, by using a single support for all positions in a block, the video coder does not need to determine the position of the target significance flag being coded prior to calculating the context for the target significance flag.

A five-point support (such as that shown in the example of FIG. 6) may provide a more accurate estimate of the value of the target significance flag than the four-point support shown in FIG. 13A. Accordingly, coding efficiency for some positions in the block (positions for which a five point support may be used for parallel context calculation) may suffer using the four point support shown in FIG. 13A. However, in some examples, the amount of time and computational resources saved by eliminating the need to determine the position of the target significance flag may outweigh potential coding efficiency gains associated with using additional support positions (e.g., a five point set of support) for some positions of the block.

FIGS. 13B and 13C illustrate additional examples of supports that may be used to enable parallel context calculation, but that are not position based. That is, as with the example described above with respect to FIG. 13A, the supports shown in FIGS. 13B and 13C may be used to calculate contexts of all positions of the respective blocks.

In the example of FIG. 13B, a video coder may calculate a context for target significance flag 290 using support 292A, 292B, 292C, and 292D. Likewise, the video coder may calculate a context for significance flag 300 using support 302A, 302B, 302C, and 302D. Both supports 292 and 302 omit a position to the right of target significance flag 290 and target significance flag 300, respectively, versus a five point support that includes such positions. The support shown in FIG. 13B may be used to calculate contexts for two positions in parallel.

In the example of FIG. 13C, a video coder may calculate a context for target significance flag 310 using support 312A, 312B, and 312C. Likewise, the video coder may calculate a context for significance flag 320 using support 322A, 322B, and 322C. Both supports 312 and 322 omit a position to the right of target significance flag 312 and target significance flag 322, respectively, and a position below target significance flag 312 and target significance flag 322, respectively, versus a five point support that includes such positions. The support shown in FIG. 13C may be used to calculate contexts for there significance flags in parallel.

As described above with respect to FIG. 13A, while holes may not be necessary for parallel context calculation for every position in the blocks, using a single set of support for calculating contexts for an entire block (e.g., one that is not position based) may reduce the computational complexity associated with calculating contexts. That is, by using a single support for all positions in a block, the video coder does not need to determine the position of the target significance flag being coded prior to calculating the context for the target significance flag.

It should be understood that the sets of supports shown in FIG. 13A-13C are provided as examples, and that other sets of support may be used to calculate contexts in parallel, including supports having more or fewer positions (or positions in different locations). The sets of support used to calculate contexts in parallel may depend, for example, on the number of transform coefficients being coded (e.g., the size of the block or sub-block), the number of contexts being calculated in parallel, the grouping of contexts being calculated in parallel, and the like.

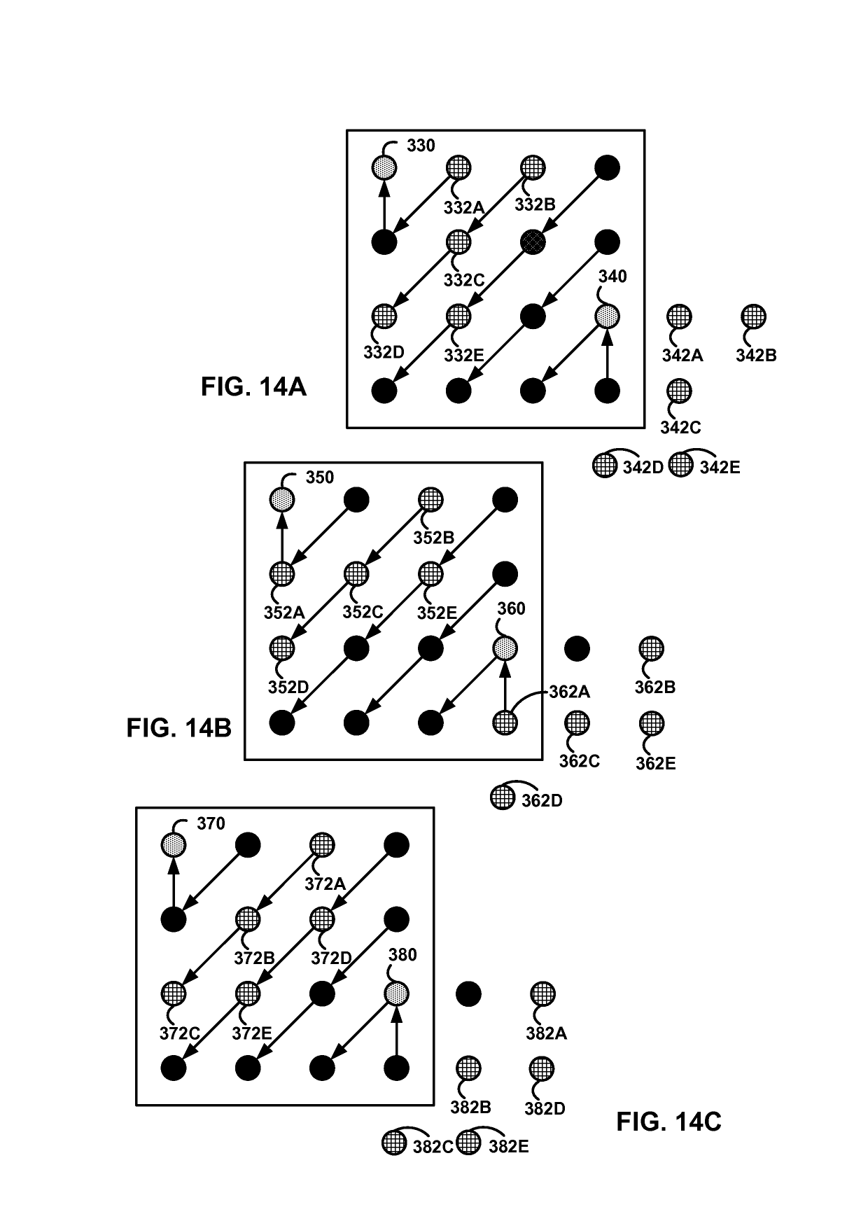

FIGS. 14A-14C illustrates examples of modified supports having holes (relative to the five point support described above) that are not position based, according to aspects of this disclosure. That is, while certain examples described above include introducing holes into a support based on the location of the significance flag being coded, the example supports shown in FIGS. 14A-14C may be used to calculate contexts for all positions in a block (or sub-block), without respect to the position being coded. Moreover, the examples shown in FIG. 14A-14C illustrate extending the supports shown in FIGS. 13A-13C by adding elements farther from the target significance flag for context calculations.

For example, with respect to FIG. 14A, a video coder may calculate a context for target significance flag 330 using support 332A, 332B, 332C, 332D, and 332E. Support 332 adds position 332E to the support 272 shown in FIG. 13A. Likewise, the video coder may calculate a context for significance flag 340 using support 342A, 342B, 342C, 342D, and 342E. Support 342 adds position 342E to the support 282 shown in FIG. 13A. In some examples, adding a significance flag may increase the accuracy of the estimation of the value of the target significance flag, thereby increasing entropy coding efficiency as described above.

With respect to FIG. 14B, a video coder may calculate a context for target significance flag 350 using support 352A, 352B, 352C, 352D, and 352E. Support 352 adds position 352E to the support 292 shown in FIG. 13B. Likewise, the video coder may calculate a context for significance flag 360 using support 362A, 362B, 362C, 362D, and 362E. Support 362 adds position 362E to the support 300 shown in FIG. 13B.

With respect to FIG. 14C, a video coder may calculate a context for target significance flag 370 using support 372A, 372B, 372C, 372D, and 372E. Support 372 adds positions 372D and 372E to support 310 shown in FIG. 13C. Likewise, the video coder may calculate a context for significance flag 380 using support 382A, 382B, 382C, 382D, and 382E. Support 382 adds positions 382D and 382E to the support 322 shown in FIG. 13C.

In some examples, one or more conditional holes may be used in conjunction with the static supports shown in FIGS. 13A-13C and FIGS. 14A-14C. For example, rather than using the static supports for calculating contexts of all positions in a block (or sub-block), a video coder (such as video encoder 20 or video decoder 30) may add conditional, position based holes for calculating contexts associated with one or more predetermined significance flags. Such a process may require determining the position of at least some of the significance flags prior to context calculation. The supports shown in FIGS. 14A-14C are provided as examples, and the techniques may be applied using supports having more or fewer positions (or positions in different locations).

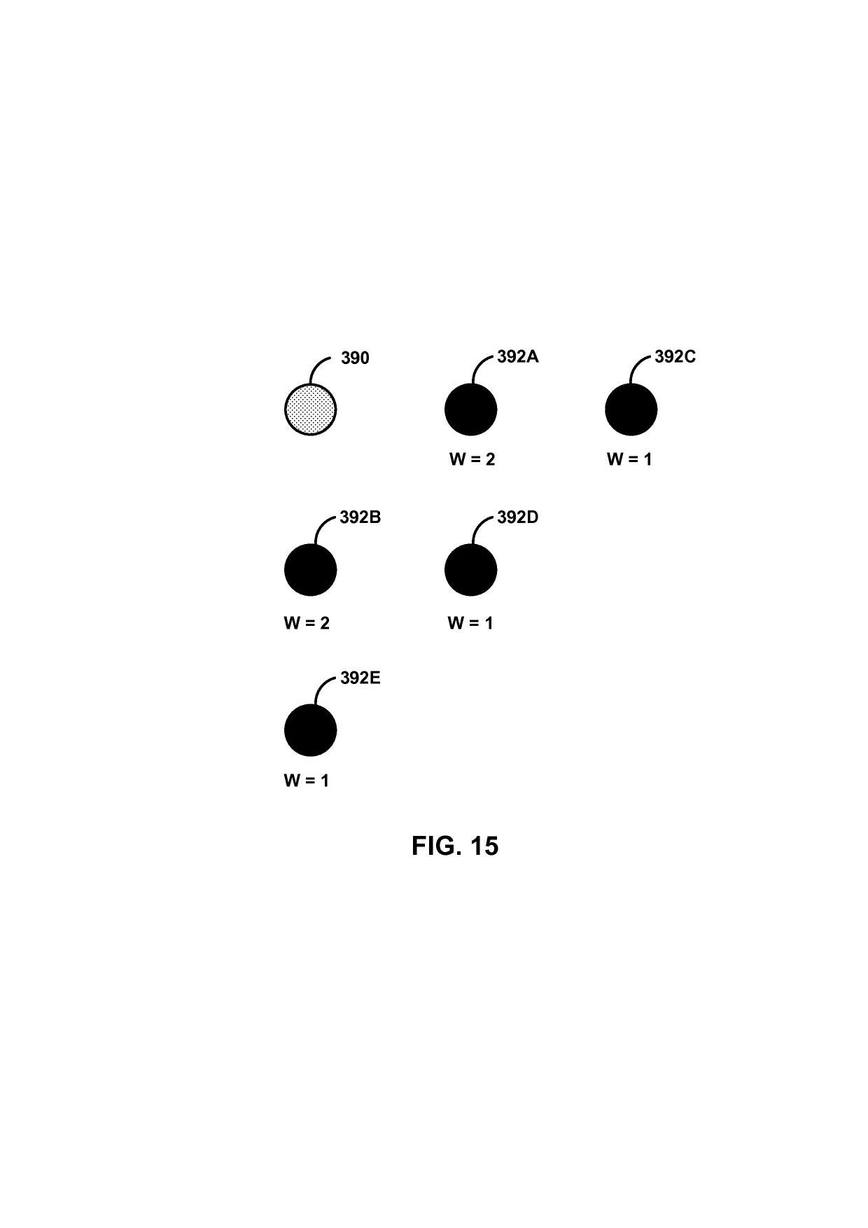

FIG. 15 illustrates applying weights to one or more positions in a set of support for context calculation, according to aspects of this disclosure. For example, as noted above, a video coder (such as video encoder 20 or video decoder 30) may use Equation (1) above to calculate context for a target significance flag, where each position in the support contributes an equal amount to the calculation.

However, certain transform coefficients in a set of support may have a better correlation with the target transform coefficient than other transform coefficients in the set support. For example, significance flags in the set of support that are positioned relatively closer to the target significance flag may provide a better indication of the value of the target significance flag than significance flags that are positioned relatively further away from the target significance flag.

Accordingly, according to aspects of this disclosure, a weighting factor w may be applied to one or more positions of a set of support. The weighting factor may increase or decrease the influence of a position on the overall context calculation. In one example, a weighting factor w may be applied according to the example shown in Equation (2) below to calculate a context model:

$$Ctx = {\sum }_{p ∈ S} ( {w}_{p} \cdot ( {coef}_{p} != 0 ) ) \qquad ( 2 )$$

In the example shown in FIG. 15, a video coder (such as video encoder 20 or video decoder 30) may calculate a context for target significance flag 390 using support 392A, 392B, 392C, 392D, and 392E. According to aspects of this disclosure, the video coder may apply a weighting factor of two to position 392A and 392B (the two positions closest to target significance flag 390) and a weighting factor w of one to positions 392C, 392D, and 392E. Accordingly, positions 392A and 392B may contribute twice as much (w=2) to a context calculation for target significance flag 390 than positions 392C, 392D, and 392E (w=1).

It should be understood that FIG. 15 is provided for purposes of example. That is, the support weighting shown and described with respect to FIG. 15 may be applied to any set of support, including those shown and described with respect to the figures above as well as supports having more or fewer positions (or positions in different locations). Accordingly, the support weighting may be applied to supports having different positions (different support shapes) than those shown in FIG. 15. Moreover, different weights (0.25, 0.5, 3, 4, and the like) may be applied to one or more of the support positions in other examples. In addition, while described with respect to calculating contexts for coding significance flags, the support weighting described above may be applied to any context calculations for entropy coding any bin value.

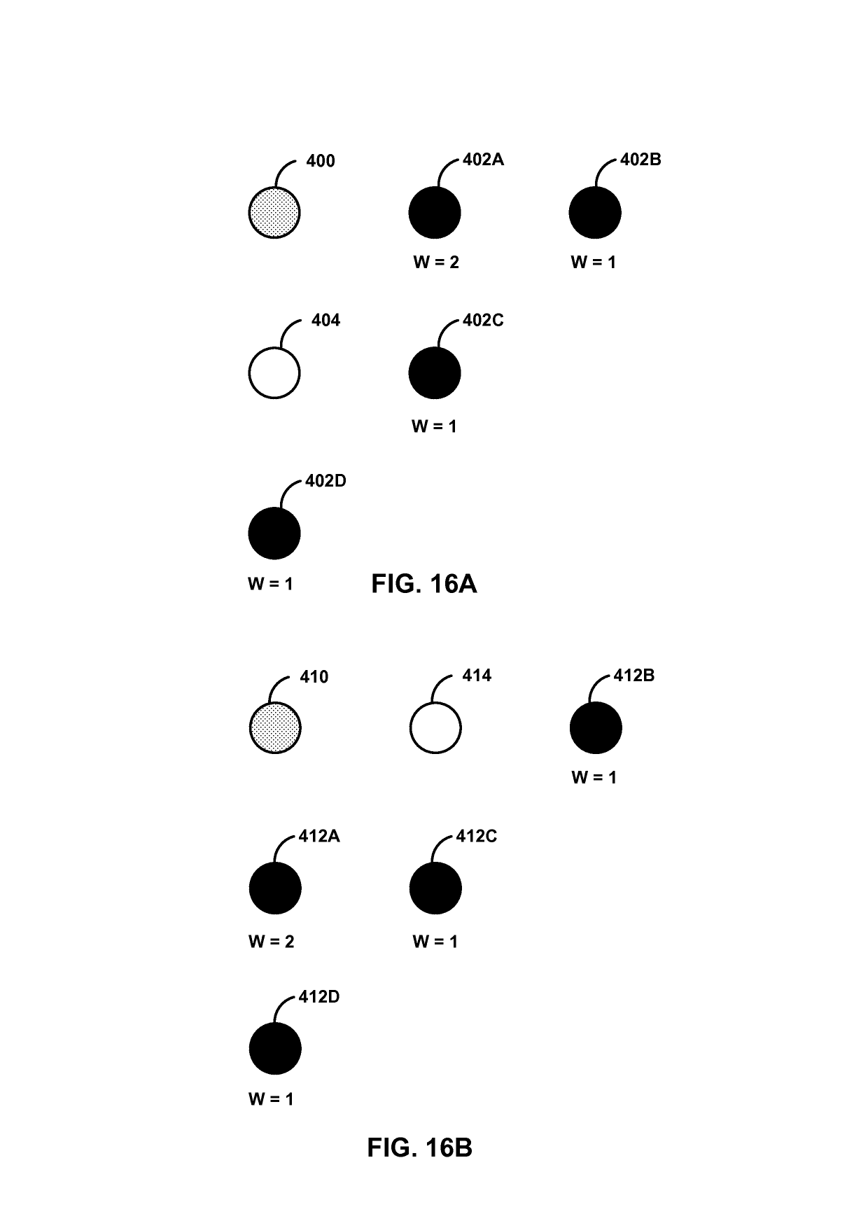

FIGS. 16A and 16B illustrate applying weights to one or more positions in a set of support for context calculation as well as introducing holes to the set of support, according to aspects of this disclosure. For example, with respect to FIG. 16A, a video coder (such as video encoder 20 or video decoder 30) may calculate context for target significance flag 400 using support 402A, 402B, 402C, and 402D (collectively, support 402). In addition, the video coder may introduce hole 404 into support 402, e.g., to remove context dependencies that may impede parallel context calculation.

According to aspects of this disclosure, the video coder may apply weights the remaining positions of support 402. The weights may compensate, in some examples, for one or more holes in support. In the example of FIG. 16A, the video coder applies a weight of two to support position 402A and a weight of one to positions 402B, 402C, and 402D. Accordingly, position 402A contributes twice as much to a context calculation than each of positions 402B, 402C, and 402D. Weighting position 402A in this way may compensate for hole 404.

With respect to FIG. 16B, the video coder may calculate context for target significance flag 410 using support 412A, 412B, 412C, and 412D (collectively, support 412). In addition, the video coder may introduce hole 414 into support 412. In the example of FIG. 16B, the video coder applies a weight of two to support position 412A and a weight of one to positions 412B, 412C, and 412D. Accordingly, position 412A contributes twice as much to a context calculation than each of positions 412B, 412C, and 412D. Weighting position 412A in this way may compensate for hole 414.

In some examples, the video coder may apply the support weighting shown in FIGS. 16A and 16B instead of filling holes with values of other transform coefficients in the block (or with other values, as described above). That is, rather than substituting a value for a hole in the support, the video coder may apply weights to remaining positions of the support. The video coder may apply weights based on the location of the hole in the support.

In this manner, FIGS. 16A and 16B represent examples of assigning weights to the remaining significant coefficient flags in a set of support, such that the sum of the weights is equal to the number of remaining significant coefficient flags, where the weights cause at least one of the remaining significant coefficient flags to be used as a substitute for an unavailable significant coefficient flag in the set of support.

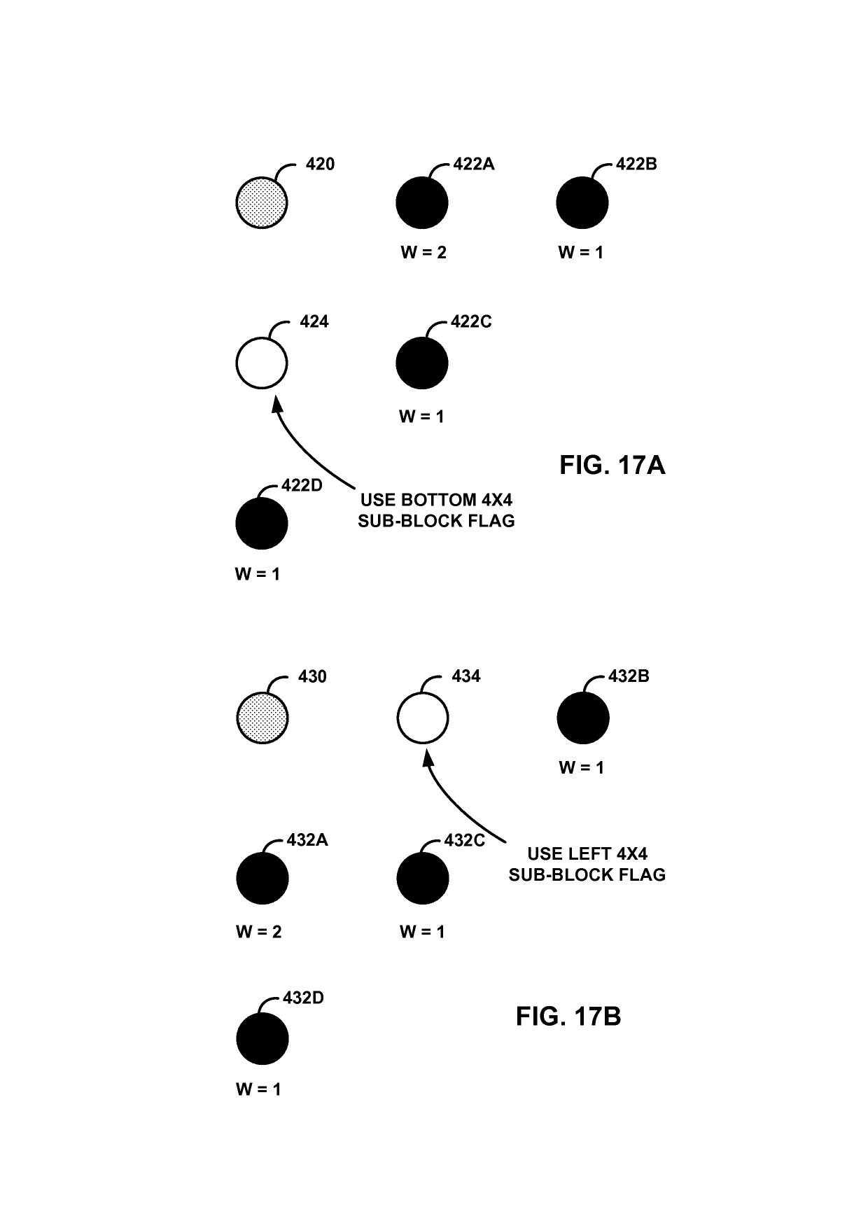

FIGS. 17A and 17B illustrate applying weights to one or more positions in a set of support for context calculation, as well as filling holes in the set of support, according to aspects of this disclosure. For example, with respect to FIG. 17A, a video coder (such as video encoder 20 or video decoder 30) may calculate context for target significance flag 420 using support 422A, 422B, 422C, and 422D (collectively, support 422). In addition, the video coder may introduce hole 424 into support 422 in the position below target significance flag 420. The video coder may also fill hole 424 by substituting another value for hole 424.

In some examples, the video coder may fill hole 424 with a value of a significant_coeffgroup_flag syntax element, such as the group flag associated with the sub-block positioned below (bottom 4×4 sub-block flag) the sub-block being coded. In other examples, the video coder may fill hole 424 with a value associated with another position in the block (or sub-block) or another value (e.g., a significant_coeffgroup_flag from another neighboring sub-block, a value from a neighboring block, and the like) may be substituted for the value at hole 424.

In addition to filling hole 424, the video coder may apply weights to the other remaining positions of support 422. In the example of FIG. 17A, the video coder applies a weight of two to support position 422A (below target significance flag 430) and a weight of one to positions 422B, 422C, and 422D. Accordingly, position 422A contributes twice as much to a context calculation than each of positions 422B, 422C, and 422D. In this way, the video coder may compensate for hole 424 by substituting a value for the hole as well as applying weights to other positions of support 422.

With respect to FIG. 17B, the video coder may calculate context for target significance flag 430 using support 432A, 432B, 432C, and 432D (collectively, support 432). In addition, the video coder may introduce hole 434 into support 432 in the position to the right of target significance flag 430. The video coder may also fill hole 434 by substituting another value for hole 434.

In some examples, the video coder may fill hole 434 with a value of a significant_coeffgroup_flag syntax element, such as the group flag associated with the sub-block positioned to the left of (left 4×4 sub-block flag) the sub-block being coded. In other examples, the video coder may fill hole 434 with a value associated with another position in the block (or sub-block) or another value (e.g., a significant_coeffgroup_flag from another neighboring sub-block, a value from a neighboring block, and the like) may be substituted for the value at hole 434.

In addition to filling hole 434, the video coder may apply weights to the other remaining positions of support 432. In the example of FIG. 17B, the video coder applies a weight of two to support position 432A (to the right of target significance flag 430) and a weight of one to positions 432B, 432C, and 432D. Accordingly, position 432A contributes twice as much to a context calculation than each of positions 432B, 432C, and 432D. In this way, the video coder may compensate for hole 434 by substituting a value for the hole as well as applying weights to other positions of support 432.

In this manner, FIGS. 17A and 17B represent examples of retrieving a value of a significant coefficient group flag of at least one of one or more sub-blocks of a parent block, and using the retrieved value to substitute for a value for a significant coefficient flag in a position of a current block of the parent block on which the current significant coefficient flag depends.

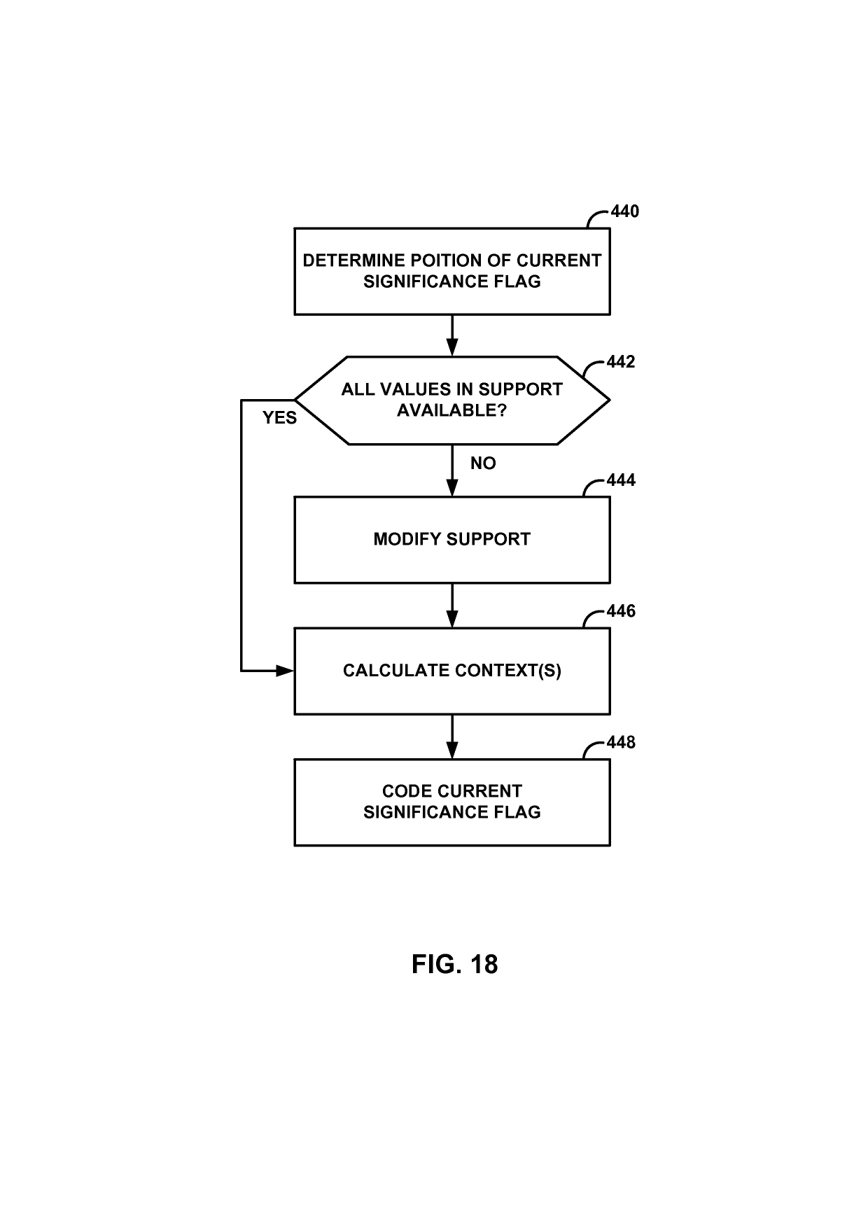

FIG. 18 is a flow diagram illustrating a technique of coding a significance flag, according to aspects of this disclosure. The example shown in FIG. 18 is generally described as being performed by a video coder. It should be understood that, in some examples, the method of FIG. 18 may be carried out by video encoder 20 (FIGS. 1 and 2), video decoder (FIGS. 1 and 3), or a variety of other processors, processing units, hardware-based coding units such as encoder/decoders (CODECs), and the like.

In the example of FIG. 18, a video coder may determine a position of a current significance flag being coded (440). For example, the video coder may determine the relative position of the current significance flag in a block of transform coefficients. In examples in which the video coder divides a block of transform coefficients into sub-blocks (as shown, for example, in FIGS. 5A and 5B) the video coder may determine the relative position of the current significance flag in a sub-block of transform coefficients.

The video coder also determines whether all values in a set of support for calculating context are available (442). As described above, the video coder may calculate contexts for more than one significance flag in parallel. In such examples, context dependencies may be present that may prevent one or more values in the support from being available for parallel context calculation.

In some examples, the video coder may determine whether all of the values in the set of support are available for context calculation based on the position of the current significance flag being coded and/or the number of contexts that are being calculated in parallel. For example, the video coder may use a five point set of support to calculate context for some positions in a block of transform coefficients, but may use a modified set of support for calculating context for other positions in the block of transform coefficients. In other examples, the video coder may use a modified set of support for coding an entire block (or sub-block) of transform coefficients. In addition, the manner in which the support is modified may be based on the number of contexts being calculated in parallel.

If not all of the values in the set of support are available, the video coder may modify the set of support (444). For example, as noted above, the video coder may introduce one or more holes into the set of support, which may enable the video coder to calculate more than one context in parallel. In some examples, the video coder may fill the holes by substituting other values for the hole positions. For example, the video coder may substitute a value associated with another position in the block (or sub-block) or another value (e.g., a value from a neighboring block, a value of a significant_coeffgroup_flag, or the like) for the position of the hole. Additionally or alternatively, the video coder may apply weights to one or more positions in the set of support.

The video coder may then calculate context for the current significance flag (446). In examples in which the video coder calculates context for more than one significance flag in parallel, the video coder may also calculate contexts for the other significance flags in parallel with the context for the current significance flag. The video coder may calculate the context, in one example, by determining a sum of the significance flags in the positions of the support (or modified support).

The video coder also codes the current significance flag (448). For example, the video coder may CABAC code the current significance flag. Accordingly, the video coder may use the determined context to determine a context model for entropy coding the current significance flag. At a video encoder (such as video encoder 20) the video encoder may use the context model to entropy encode the significance flag, thereby including an indication of the value of the current significance flag in an encoded bitstream. At a video decoder (such as video decoder 30) the video decoder may use the context model to entropy decode the significance flag, thereby parsing the current significance flag from an encoded bitstream.

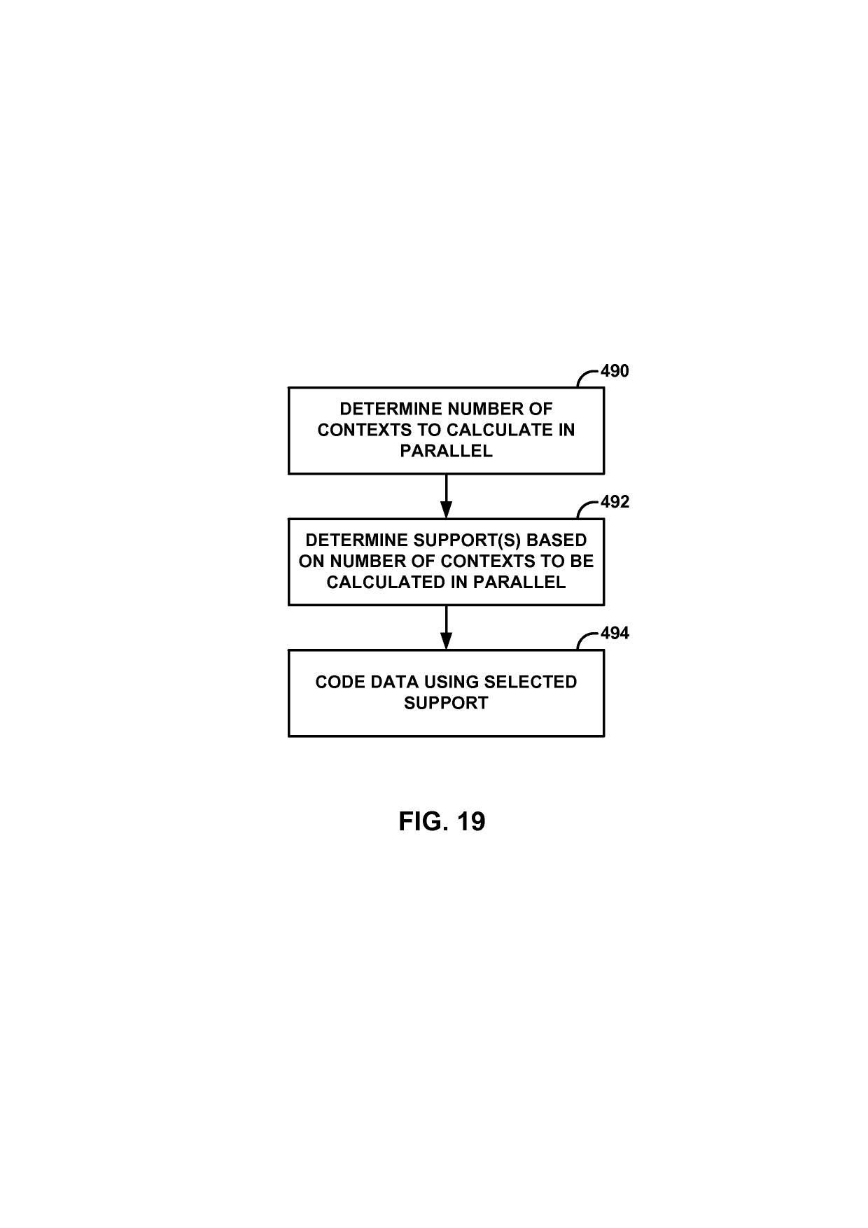

FIG. 19 is a flow diagram illustrating a technique of entropy coding video data, according to aspects of this disclosure. The example shown in FIG. 19 is generally described as being performed by a video coder. It should be understood that, in some examples, the method of FIG. 19 may be carried out by video encoder 20 (FIGS. 1 and 2), video decoder (FIGS. 1 and 3), or a variety of other processors, processing units, hardware-based coding units such as encoder/decoders (CODECs), and the like.

In the example of FIG. 19, the video coder may initially determine a number of contexts for context-adaptive binary coding to calculate in parallel (490). The number of contexts to calculate in parallel may, in some examples, may be a predetermined value. The number of contexts that are calculated in parallel may be defined, for example, according to a profile or level of a video coding standard such that a video coder conforming to a particular profile or level may be preconfigured to calculate a number of contexts in parallel. In other examples, an indication of the number of context to be calculated in parallel may be included in an encoded bitstream.

The video coder may determine one or more supports of calculating context based on the number of contexts being calculated in parallel (492). For example, as described above with respect to FIGS. 8A-8C, the video coder may use a different support for calculating two contexts in parallel than the video coder uses for calculating three contexts in parallel. In some examples, in addition to determining a support based on the number of contexts being coded in parallel, as noted above, the video coder may use different supports based on a relative location of the symbol being coded (e.g., in a block or sub-block of transform coefficients).

The video coder may then code one or more bins of data using the determined supports (494). For example, the video coder may use the determined support for parallel context calculation, which may define a context models for context-adaptive entropy coding of one or more bins. At a video encoder (such as video encoder 20), the video encoder may use the context models to entropy encode one or more bins of data for an encoded bitstream. At a video decoder (such as video decoder 30), the video decoder may use the context models to entropy decode one or more bins of data from an encoded bitstream.

Certain aspects of this disclosure have been described with respect to the developing HEVC standard for purposes of illustration. However, the techniques described in this disclosure may be useful for other video coding processes, such as those defined according to H.264 or other standard or proprietary video coding processes not yet developed.

In addition, while certain examples above have been described with respect to coding significance flags, aspects of this disclosure may be applied to coding bins associated with other values or symbols. For example, the techniques for determining a set of support may be applied to a variety of context-adaptive entropy coding schemes for coding a variety of bins, including bins associated with transform coefficients as well as other symbols. Accordingly, the examples described above with respect to determining a set of support for significance flags are provided as non-limiting examples only.

Moreover, references to an initial five point support are provided for purposes of example, and other supports having more or fewer than five positions (or positions in other locations) may also be used in accordance with the techniques described herein. In addition, it should be understood that the position of holes (as well as the location of substitute values and/or weighting) in a set of support described above may be dependent on the scan order. That is, for example, FIGS. 5A-14C generally illustrate a 4×4 block of coefficients (which may be forms as sub-blocks of a larger block of transform coefficients) being scanned in a reverse diagonal scan pattern. In other examples, however, more or fewer coefficients may be scanned. Moreover, an alternative scan pattern may be used (e.g., vertical, horizontal, zig-zag, and the like). In such examples, the location of holes (as well as the location of substitute values and/or weighting) may be alternatively arranged in order to support parallel context calculation in accordance with the techniques of this disclosure.

A video coder, as described in this disclosure, may refer to a video encoder or a video decoder (such as, for example, video encoder 20 or video decoder 30). Similarly, a video coding unit may refer to a video encoder or a video decoder. Likewise, video coding may refer to video encoding or video decoding.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of coding video data, the method comprising:
determining that a set of support for selecting a context model to code a current significant coefficient flag of a transform coefficient of a block of video data includes at least one significant coefficient flag that is not available;
based on the determination, modifying the set of support;
calculating a context for the current significant coefficient flag using the modified set of support; and
applying context-adaptive binary arithmetic coding (CABAC) to code the current significant coefficient flag based on the calculated context.

2. The method of claim 1, wherein modifying the set of support comprises removing the at least one significant coefficient flag from the set of support.

3. The method of claim 1,
wherein modifying the set of support comprises substituting a value for a value of the at least one significant coefficient flag, and
wherein calculating the context comprises using the substituted value for the at least one significant coefficient flag and actual values for remaining significant coefficient flags in the set of support.

4. The method of claim 3, wherein substituting the value comprises retrieving a value for the at least one significant coefficient flag from a transform coefficient outside the set of support.

5. The method of claim 3, wherein substituting the value comprises retrieving sub-block significance group flag from a sub-block that neighbors a sub-block containing the current significant coefficient flag.

6. The method of claim 1, wherein modifying the set of support comprises assigning weights to one or more significant coefficient flags in the set of support.

7. The method of claim 6, wherein modifying the set of support further comprises removing the at least one significant coefficient flag from the set of support, and wherein assigning weights to the one or more significant coefficient flags comprises assigning weights such that the sum of the weights is equal to a number of remaining significant coefficient flags in the set of support.

8. The method of claim 1, further comprising determining that the at least one significant coefficient flag is not available due to calculating a second context for the at least one significance coefficient flag in parallel with the current significant coefficient flag.

9. The method of claim 8, further comprising:
calculating a second context for coding a second significant coefficient flag in parallel with the current significant coefficient flag; and
applying CABAC to code the second significant coefficient flag based on the calculated second context.

10. The method of claim 1, further comprising grouping a set of significant coefficient flags that includes the current significant coefficient flag to be calculated in parallel, and wherein modifying the set of support comprises removing at least one of the significant coefficient flags from the set of support based on the grouping.

11. The method of claim 1, further comprising applying the modified set of support to calculate a context for each position in a block of transform coefficients that includes the current significant coefficient flag.

12. The method of claim 1, wherein applying CABAC to code the current significant coefficient flag based on the calculated context comprises applying CABAC to encode the current significant coefficient flag.

13. The method of claim 1, wherein applying CABAC to code the current significant coefficient flag based on the calculated context comprises applying CABAC to decode the current significant coefficient flag.

14. An apparatus for coding video data, the apparatus comprising one or more processors configured to:
determine that a set of support for selecting a context model to code a current significant coefficient flag of a transform coefficient of a block of video data includes at least one significant coefficient flag that is not available;
based on the determination, modify the set of support;
calculate a context for the current significant coefficient flag using the modified set of support; and
apply context-adaptive binary arithmetic coding (CABAC) to code the current significant coefficient flag based on the calculated context.

15. The apparatus of claim 14, to wherein modify the set of support, the one or more processors are configured to remove the at least one significant coefficient flag from the set of support.

16. The apparatus of claim 14,
wherein to modify the set of support, the one or more processors are configured to substitute a value for a value of the at least one significant coefficient flag, and
wherein to calculate the context, the one or more processors are configured to use the substituted value for the at least one significant coefficient flag and actual values for remaining significant coefficient flags in the set of support.

17. The apparatus of claim 16, wherein to substitute the value, the one or more processors are configured to retrieve a value for the at least one significant coefficient flag from a transform coefficient outside the set of support.

18. The apparatus of claim 16, wherein to substitute the value, the one or more processors are configured to retrieve sub-block significance group flag from a sub-block that neighbors a sub-block containing the current significant coefficient flag.

19. The apparatus of claim 14, wherein to modify the set of support, the one or more processors are configured to assign weights to one or more significant coefficient flags in the set of support.

20. The apparatus of claim 19, wherein to modify the set of support, the one or more processors are configured to remove the at least one significant coefficient flag from the set of support, and wherein to assign weights to the one or more significant coefficient flags, the one or more processors are configured to assign weights such that the sum of the weights is equal to a number of remaining significant coefficient flags in the set of support.

21. The apparatus of claim 14, wherein the one or more processors are further configured to determine that the at least one significant coefficient flag is not available due to calculating a second context for the at least one significance coefficient flag in parallel with the current significant coefficient flag.

22. The apparatus of claim 21, wherein the one or more processors are further configured to:
calculate a second context for coding a second significant coefficient flag in parallel with the current significant coefficient flag; and
apply CABAC to code the second significant coefficient flag based on the calculated second context.

23. The apparatus of claim 14, wherein the one or more processors are further configured to group a set of significant coefficient flags that includes the current significant coefficient flag to be calculated in parallel, and wherein to modify the set of support, the one or more processors are configured to remove at least one of the significant coefficient flags from the set of support based on the grouping.

24. The apparatus of claim 14, wherein the one or more processors are further configured to apply the modified set of support to calculate a context for each position in a block of transform coefficients that includes the current significant coefficient flag.

25. The apparatus of claim 14, wherein to apply CABAC to code the current significant coefficient flag based on the calculated context, the one or more processors are configured to apply CABAC to encode the current significant coefficient flag.

26. The apparatus of claim 14, wherein to apply CABAC to code the current significant coefficient flag based on the calculated context, the one or more processors are configured to apply CABAC to decode the current significant coefficient flag.

27. An apparatus for coding video data, the apparatus comprising:
means for determining that a set of support for selecting a context model to code a current significant coefficient flag of a transform coefficient of a block of video data includes at least one significant coefficient flag that is not available;
based on the determination, means for modifying the set of support;
means for calculating a context for the current significant coefficient flag using the modified set of support; and
means for applying context-adaptive binary arithmetic coding (CABAC) to code the current significant coefficient flag based on the calculated context.

28. The apparatus of claim 27, wherein means for modifying the set of support comprises means for removing the at least one significant coefficient flag from the set of support.

29. The apparatus of claim 27,
wherein means for modifying the set of support comprises means for substituting a value for a value of the at least one significant coefficient flag, and
wherein means for calculating the context comprises means for using the substituted value for the at least one significant coefficient flag and actual values for remaining significant coefficient flags in the set of support.

30. The apparatus of claim 29, wherein means for substituting the value comprises means for retrieving a value for the at least one significant coefficient flag from a transform coefficient outside the set of support.

31. The apparatus of claim 29, wherein means for substituting the value comprises means for retrieving sub-block significance group flag from a sub-block that neighbors a sub-block containing the current significant coefficient flag.

32. The apparatus of claim 27, wherein means for modifying the set of support comprises means for assigning weights to one or more significant coefficient flags in the set of support.

33. The apparatus of claim 32, wherein means for modifying the set of support further comprises means for removing the at least one significant coefficient flag from the set of support, and wherein means for assigning weights to the one or more significant coefficient flags comprises means for assigning weights such that the sum of the weights is equal to a number of remaining significant coefficient flags in the set of support.

34. The apparatus of claim 27, further comprising means for determining that the at least one significant coefficient flag is not available due to calculating a second context for the at least one significance coefficient flag in parallel with the current significant coefficient flag.

35. The apparatus of claim 34, further comprising:
means for calculating a second context for coding a second significant coefficient flag in parallel with the current significant coefficient flag; and
means for applying CABAC to code the second significant coefficient flag based on the calculated second context.

36. The apparatus of claim 27, further comprising means for grouping a set of significant coefficient flags that includes the current significant coefficient flag to be calculated in parallel, and wherein means for modifying the set of support comprises means for removing at least one of the significant coefficient flags from the set of support based on the grouping.

37. The apparatus of claim 27, further comprising means for applying the modified set of support to calculate a context for each position in a block of transform coefficients that includes the current significant coefficient flag.

38. The apparatus of claim 27, wherein means for applying CABAC to code the current significant coefficient flag based on the calculated context comprises means for applying CABAC to encode the current significant coefficient flag.

39. The apparatus of claim 27, wherein means for applying CABAC to code the current significant coefficient flag based on the calculated context comprises means for applying CABAC to decode the current significant coefficient flag.

40. A non-transitory computer-readable storage medium having instructions stored thereon that, when executed, cause one or more processors to:
determine that a set of support for selecting a context model to code a current significant coefficient flag of a transform coefficient of a block of video data includes at least one significant coefficient flag that is not available;
based on the determination, modify the set of support;
calculate a context for the current significant coefficient flag using the modified set of support; and
apply context-adaptive binary arithmetic coding (CABAC) to code the current significant coefficient flag based on the calculated context.

41. The non-transitory computer-readable storage medium of claim 40, to wherein modify the set of support, the instructions cause the one or more processors to remove the at least one significant coefficient flag from the set of support.

42. The non-transitory computer-readable storage medium of claim 40,
wherein to modify the set of support, the instructions cause the one or more processors to substitute a value for a value of the at least one significant coefficient flag, and
wherein to calculate the context, the instructions cause the one or more processors to use the substituted value for the at least one significant coefficient flag and actual values for remaining significant coefficient flags in the set of support.

43. The non-transitory computer-readable storage medium of claim 42, wherein to substitute the value, the instructions cause the one or more processors to retrieve a value for the at least one significant coefficient flag from a transform coefficient outside the set of support.

44. The non-transitory computer-readable storage medium of claim 42, wherein to substitute the value, the instructions cause the one or more processors to retrieve sub-block significance group flag from a sub-block that neighbors a sub-block containing the current significant coefficient flag.

45. The non-transitory computer-readable storage medium of claim 40, wherein to modify the set of support, the instructions cause the one or more processors to assign weights to one or more significant coefficient flags in the set of support.

46. The non-transitory computer-readable storage medium of claim 45, wherein to modify the set of support, the instructions cause the one or more processors to remove the at least one significant coefficient flag from the set of support, and wherein to assign weights to the one or more significant coefficient flags, the instructions cause the one or more processors to assign weights such that the sum of the weights is equal to a number of remaining significant coefficient flags in the set of support.

47. The non-transitory computer-readable storage medium of claim 40, wherein the instructions further cause one or more processors to determine that the at least one significant coefficient flag is not available due to calculating a second context for the at least one significance coefficient flag in parallel with the current significant coefficient flag.

48. The non-transitory computer-readable storage medium of claim 47, wherein the instructions further cause the one or more processors to:
calculate a second context for coding a second significant coefficient flag in parallel with the current significant coefficient flag; and
apply CABAC to code the second significant coefficient flag based on the calculated second context.

49. The non-transitory computer-readable storage medium of claim 40, wherein the instructions further cause the one or more processors to group a set of significant coefficient flags that includes the current significant coefficient flag to be calculated in parallel, and wherein to modify the set of support, the instructions cause the one or more processors to remove at least one of the significant coefficient flags from the set of support based on the grouping.

50. The non-transitory computer-readable storage medium of claim 40, wherein the instructions further cause the one or more processors to apply the modified set of support to calculate a context for each position in a block of transform coefficients that includes the current significant coefficient flag.

51. The non-transitory computer-readable storage medium of claim 40, wherein to apply CABAC to code the current significant coefficient flag based on the calculated context, the instructions cause the one or more processors to apply CABAC to encode the current significant coefficient flag.

52. The non-transitory computer-readable storage medium of claim 40, wherein to apply CABAC to code the current significant coefficient flag based on the calculated context, the instructions cause the one or more processors to apply CABAC to decode the current significant coefficient flag.
